(19) United States
(12) Patent Application Publication
(10) Pub. No.: US 2026/0161249 A1
(43) Pub. Date: Jun. 11, 2026

(54) ELECTRONIC DEVICE AND METHOD OF DRIVING ELECTRONIC DEVICE

(71) Applicant: Samsung Display Co., Ltd., Yongin-si (KR)

(72) Inventors: HYUNGBAE KIM, Yongin-si (KR); SANGHYUN LIM, Yongin-si (KR)

(21) Appl. No.: 19/182,117

(22) Filed: Apr. 17, 2025

(30) Foreign Application Priority Data
Jun. 25, 2024 (KR) 10-2024-0083081

(51) Int. Cl. G06F 3/041; G06F 3/0354; G06F 3/044; G06F 3/046

(52) U.S. Cl. CPC G06F 3/04166; G06F 3/03545; G06F 3/0446; G06F 3/046; G06F 3/04164; G06F 2203/04106; G06F 2203/04111; G06F 2203/04112

(57) ABSTRACT

Disclosed is an electronic device including charging electrodes arranged in a first direction, primary binder circuits configured to be selectively connected to one or more of the charging electrodes, and including first switches connected to a first node, and secondary binder circuits configured to be selectively connected to one or more of the primary binder circuits, and including second switches connected to a second node.

### CROSS-REFERENCE TO RELATED APPLICATION

The present application claims priority to, and the benefit of, Korean Patent Application No. 10-2024-0083081, filed on Jun. 25 2024, in the Korean Intellectual Property Office, the entire disclosure of which is incorporated herein by reference.

### BACKGROUND

Embodiments of the present disclosure described herein relate to an electronic device having improved pen-charging sensitivity and improved pen-charging efficiency, and a method of driving an electronic device.

Multimedia electronic devices, such as a television (TV), a mobile phone, a tablet computer, a laptop, a navigation system, and a game console, include a display device for displaying an image. In addition to a general input method, such as a button, a keyboard, and a mouse, electronic devices may include a sensor layer (or an input sensor) capable of providing a touch-based input method that allows a user to input information or commands suitably and intuitively. The sensor layer may sense a touch or pressure by the user. Meanwhile, the demand of use of a pen for detailed touch input for the user who is accustomed to inputting information using a writing instrument or a specific application (e.g., an application for sketching or drawing) is increasing.

### SUMMARY

Embodiments of the present disclosure provide an electronic device having improved pen-charging sensitivity and improved pen-charging efficiency, and a method of driving an electronic device.

According to one or more embodiments, an electronic device includes charging electrodes arranged in a first direction, primary binder circuits configured to be selectively connected to one or more of the charging electrodes, and including first switches connected to a first node, and secondary binder circuits configured to be selectively connected to one or more of the primary binder circuits, and including second switches connected to a second node.

The secondary binder circuits may include a first transfer circuit configured to receive a first signal, and a second transfer circuit configured to receive a second signal that is different from the first signal.

The charging electrodes may include W first loop electrodes electrically connected to the first transfer circuit, W being an integer that is greater than or equal to one, and X second loop electrodes electrically connected to the second transfer circuit, X being an integer that is greater than or equal to one, wherein W and X are variable values.

The primary binder circuits may include Y first intermediate transfer circuits electrically connected to the first transfer circuit, Y being an integer that is greater than or equal to one, and Z second intermediate transfer circuits electrically connected to the second transfer circuit, Z being an integer that is greater than or equal to one, wherein Y and Z are variable values.

The charging electrodes may include W first loop electrodes electrically connected to the Y first intermediate transfer circuits, W being an integer that is greater than or equal to one, and X second loop electrodes electrically connected to the Z second intermediate transfer circuits, X being an integer that is greater than or equal to one, wherein W and X are variable values.

There may be defined a charging loop including the first transfer circuit, the Y first intermediate transfer circuits, the W first loop electrodes, the second transfer circuit, the Z second intermediate transfer circuits, and the X second loop electrodes.

The electronic device may further include a sensor driver configured to output the first signal and the second signal, wherein, when the sensor driver is operated in a first charging drive mode, the charging loop includes a first charging loop in a first time interval in the first charging drive mode, and a second charging loop in a second time interval that is temporally continuous with the first time interval, wherein the W first loop electrodes in the first charging loop and the W first loop electrodes in the second charging loop do not overlap each other, and wherein the X second loop electrodes in the first charging loop and the X second loop electrodes in the second charging loop do not overlap each other.

When the sensor driver is operated in a second charging drive mode that is different from the first charging drive mode, the charging loop may include a first fine charging loop in a first time interval in the second charging drive mode, and a second fine charging loop in a second time interval that is temporally continuous with the first time interval in the second charging drive mode, wherein one or more of the W first loop electrodes in the first fine charging loop, and one or more of the W first loop electrodes in the second fine charging loop, overlap each other, and wherein one or more of the X second loop electrodes in the first fine charging loop, and one or more of the X second loop electrodes in the second fine charging loop, overlap each other.

When an input by a pen is sensed in the first charging drive mode, the sensor driver may be configured to be switched from the first charging drive mode to a first local charging drive mode, and wherein, in the first local charging drive mode, the sensor driver is configured to output the first signal to the W first loop electrodes, and to output the second signal to the X second loop electrodes, so that the charging loop overlaps an area in which the input by the pen is sensed.

The sensor driver may be configured to be operated in the first local charging drive mode and then switched to the second charging drive mode, wherein the W first loop electrodes in the first fine charging loop, and the W first loop electrodes in the second fine charging loop, overlap one or more of the W first loop electrodes in the charging loop in the first local charging drive mode, wherein the X second loop electrodes in the first fine charging loop, and the X second loop electrodes in the second fine charging loop, overlap one or more of the X second loop electrodes in the charging loop in the first local charging drive mode, wherein the sensor driver is configured to be operated in the second charging drive mode and then switched to a second local charging drive mode, and wherein the charging loop in the second local charging drive mode is one of the first fine charging loop or the second fine charging loop in the second charging drive mode.

The charging electrodes may include U gap electrodes between the W first loop electrodes and the X second loop electrodes, U being an integer that is greater than or equal to one, wherein the W first loop electrodes, the U gap electrodes, and the X second loop electrodes are continuously and sequentially arranged in the first direction.

The electronic device may further include first electrodes overlapping the charging electrodes in one-to-one correspondence, and second electrodes crossing the first electrodes, and spaced apart from each other in a second direction crossing the first direction.

According to one or more embodiments, an electronic device includes first electrodes arranged in a first direction, and extending in a second direction crossing the first direction, second electrodes arranged in the second direction, and extending in the first direction, third electrodes arranged in the first direction, and extending in the second direction, primary binder circuits configured to be selectively connected to one or more of the third electrodes, secondary binder circuits configured to be selectively connected to one or more of the primary binder circuits, and a sensor driver configured to provide a charging loop by outputting a first signal to at least one of the secondary binder circuits, and by outputting a second signal that is different from the first signal to at least one other of the secondary binder circuits in a charging drive mode.

The primary binder circuits may include first switches connected to a first node, wherein the secondary binder circuits include second switches connected to a second node.

The third electrodes may include W first loop electrodes configured to receive the first signal, W being an integer that is greater than or equal to one, X second loop electrodes configured to receive the second signal, X being an integer that is greater than or equal to one, and U gap electrodes between the W first loop electrodes and the X second loop electrodes, U being an integer that is greater than or equal to one, wherein the W first loop electrodes, the U gap electrodes, and the X second loop electrodes are continuously and sequentially arranged in the first direction, wherein the charging loop includes the W first loop electrodes and the X second loop electrodes, wherein the charging drive mode includes a first charging drive mode, a first local charging drive mode, a second charging drive mode, and a second local charging drive mode, and wherein, when an input by a pen is sensed in the first charging drive mode, the sensor driver is configured to be sequentially switched to the first local charging drive mode, the second charging drive mode, and the second local charging drive mode.

In each of the first local charging drive mode and the second local charging drive mode, connection between the primary binder circuits and the secondary binder circuits may be controlled so that the charging loop overlaps an area in which the input by the pen is sensed.

In the first charging drive mode and the second charging drive mode, the charging loop may be provided as a plurality of charging loops spaced apart from each other in the first direction, wherein a pitch between the charging loops in the first charging drive mode is greater than a pitch between the charging loops in the second charging drive mode.

According to one or more embodiments, a method of driving an electronic device includes controlling primary binder circuits to be selectively connected to one or more of charging electrodes arranged in a first direction, controlling secondary binder circuits to be selectively connected to one or more of the primary binder circuits, and outputting a first signal to at least one of the secondary binder circuits, outputting a second signal that is different from the first signal to at least one other of the secondary binder circuits, and forming a charging loop including one or more of the charging electrodes.

The method may further include sequentially forming the charging loop while the charging loop moves in the first direction in a first charging drive mode.

The method may further include switching the first charging drive mode to a first local charging drive mode, when an input by a pen is sensed in the first charging drive mode, to form the charging loop overlapping an area in which the input by the pen is sensed, switching to a second charging drive mode from the first local charging drive mode, and sequentially forming the charging loop while the charging loop moves in the first direction in the second charging drive mode, wherein a pitch between adjacent charging loops in the first charging drive mode is greater than a pitch between adjacent charging loops in the second charging drive mode.

### BRIEF DESCRIPTION OF THE DRAWINGS

The above and other aspects of the present disclosure will become apparent by describing in detail embodiments thereof with reference to the accompanying drawings.

FIG. 1A is a perspective view of an electronic device according to one or more embodiments of the present disclosure.

FIG. 1B is a rear perspective view of the electronic device according to one or more embodiments of the present disclosure.

FIG. 2 is a perspective view of the electronic device according to one or more embodiments of the present disclosure.

FIG. 3 is a perspective view of the electronic device according to one or more embodiments of the present disclosure.

FIG. 4 is a schematic cross-sectional view of a display panel according to one or more embodiments of the present disclosure.

FIG. 5 is a view for describing an operation of the electronic device according to one or more embodiments of the present disclosure.

FIG. 6A is a cross-sectional view of the display panel according to one or more embodiments of the present disclosure.

FIG. 6B is a cross-sectional view illustrating some components of a sensor layer according to one or more embodiments of the present disclosure.

FIG. 7 is a plan view of a sensor layer according to one or more embodiments of the present disclosure.

FIG. 8A is a plan view illustrating a first conductive layer of a sensing unit according to one or more embodiments of the present disclosure.

FIG. 8B is an enlarged plan view of an area XX′ illustrated in FIG. 8A.

FIG. 9A is a plan view illustrating a second conductive layer of the sensing unit according to one or more embodiments of the present disclosure.

FIG. 9B is an enlarged plan view of an area YY′ illustrated in FIG. 9A.

FIG. 10 is a plan view illustrating some components of the sensing unit according to one or more embodiments of the present disclosure.

FIG. 11 is a view illustrating an operation of a sensor driver according to one or more embodiments of the present disclosure.

FIG. 12 is a view illustrating the operation of the sensor driver according to one or more embodiments of the present disclosure.

FIG. 13 is a view for describing a first mode according to one or more embodiments of the present disclosure.

FIG. 14 is a view for describing a second mode, for example, a charging drive mode, according to one or more embodiments of the present disclosure.

FIG. 15A is a graph depicting a waveform of a first signal according to one or more embodiments of the present disclosure.

FIG. 15B is a graph depicting a waveform of a second signal according to one or more embodiments of the present disclosure.

FIG. 16 is a view for describing the second mode, for example, a pen-sensing drive mode, according to one or more embodiments of the present disclosure.

FIG. 17 is a view for describing the second mode based on the sensing unit according to one or more embodiments of the present disclosure.

FIG. 18 is a view for describing the second mode, for example, a pen-charging drive mode, according to one or more embodiments of the present disclosure.

FIG. 19 is a table representing signals provided to the sensor layer according to one or more embodiments of the present disclosure.

FIG. 20 is a flowchart illustrating a method of driving the sensor layer according to one or more embodiments of the present disclosure.

FIG. 21 is a table representing signals provided to the sensor layer in a first charging drive mode according to one or more embodiments of the present disclosure.

FIG. 22 is a view for describing a first local charging drive mode according to one or more embodiments of the present disclosure.

FIG. 23A is a view illustrating one charging loop and pen positions according to one or more embodiments of the present disclosure.

FIG. 23B is a graph depicting charging sensitivity according to the charging loop and the pen position illustrated in FIG. 23A.

FIG. 24 is a table representing signals provided to the sensor layer in a second charging drive mode according to one or more embodiments of the present disclosure.

FIG. 25 is a view for describing a second local charging drive mode according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

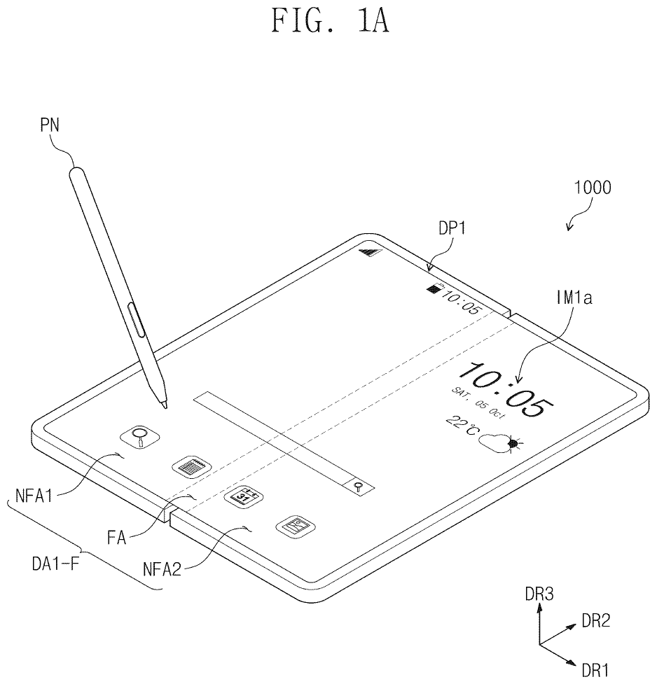

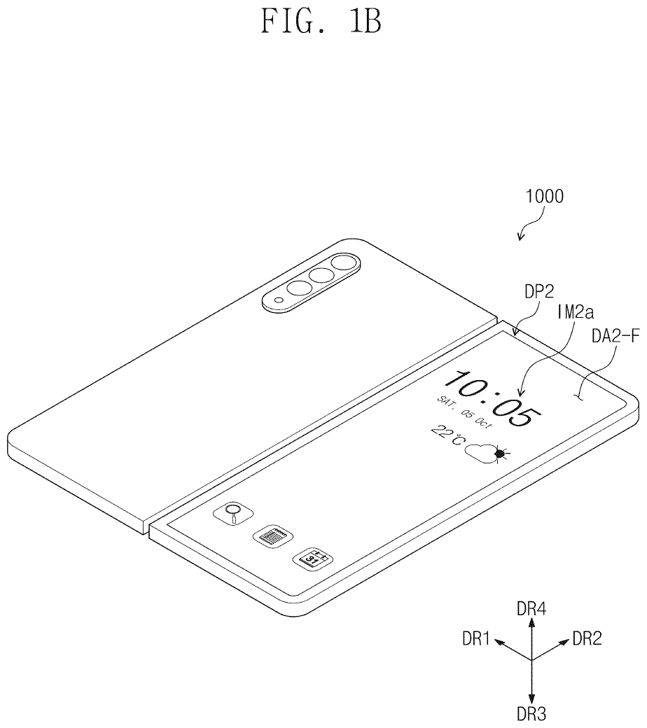

FIG. 1A is a perspective view of an electronic device 1000 according to one or more embodiments of the present disclosure. FIG. 1B is a rear perspective view of the electronic device 1000 according to one or more embodiments of the present disclosure.

Referring to FIGS. 1A and 1B, the electronic device 1000 may be a device that is activated according to an electrical signal. For example, the electronic device 1000 may display an image, and may sense inputs applied from the outside. The external input may be an input of the user. The input of the user may include various types of external inputs, such as a portion of a human body of the user, a pen PN, a light, heat, or pressure.

The electronic device 1000 may include a first display panel DP1 and a second display panel DP2. The first display panel DP1 and the second display panel DP2 may be separate panels that are separated from each other. The first display panel DP1 may be referred to as a main display panel, and the second display panel DP2 may be referred to as an auxiliary display panel or an external display panel.

The first display panel DP1 may include a first display part DA1-F, and the second display panel DP2 may include a second display part DA2-F. An area of the second display panel DP2 may be smaller than an area of the first display panel DP1. To correspond to the sizes of the first display panel DP1 and the second display panel DP2, an area of the first display part DA1-F may be larger than an area of the second display part DA2-F.

In a state in which the electronic device 1000 is unfolded, the first display part DA1-F may have a plane substantially parallel to a first direction DR1 and a second direction DR2. A thickness direction of the electronic device 1000 may be parallel to a third direction DR3 crossing the first direction DR1 and the second direction DR2. Thus, front surfaces (or upper surfaces) and rear surfaces (or lower surfaces) of members constituting the electronic device 1000 may be defined based on the third direction DR3.

The first display panel DP1 or the first display part DA1-F may include a folding area FA that is folded or unfolded and a plurality of non-folding areas NFA1 and NFA2 spaced apart from each other with the folding area FA interposed therebetween. The second display panel DP2 may overlap one of the plurality of non-folding areas NFA1 or NFA2. For example, the second display panel DP2 may overlap the first non-folding area NFA1.

A display direction of a first image IM1a displayed on a portion of the first display panel DP1, for example, the first non-folding area NFA1, may be opposite to a display direction of a second image IM2a displayed on the second display panel DP2. For example, the first image IM1a may be displayed in the third direction DR3, and the second image IM2a may be displayed in a fourth direction DR4 that is opposite to the third direction DR3.

In one or more embodiments of the present disclosure, the folding area FA may be bent with respect to a folding axis extending in a direction parallel to long sides of the electronic device 1000, for example, a direction parallel to the second direction DR2. In a state in which the electronic device 1000 is folded, the folding area FA has a curvature (e.g., predetermined curvature) and a radius of curvature (e.g., predetermined radius of curvature). The first non-folding area NFA1 and the second non-folding area NFA2 may face each other, and the electronic device 1000 may be inner-folded so that the first display part DA1-F is not exposed to the outside.

In one or more embodiments of the present disclosure, the electronic device 1000 may be outer-folded so that the first display part DA1-F is exposed to the outside. In one or more embodiments of the present disclosure, the electronic device 1000 may be both inner-folded or outer-folded in an unfolded state, but the present disclosure is not limited thereto.

FIG. 1A illustrates that one folding area FA is defined (provided or included) in the electronic device 1000, but the present disclosure is not limited thereto. For example, a plurality of folding axes and a plurality of folding areas corresponding thereto may be defined in the electronic device 1000, and the electronic device 1000 may be inner-folded or outer-folded in a state in which each of the plurality of folding areas is unfolded.

According to one or more embodiments of the present disclosure, even when at least one of the first display panel DP1 or the second display panel DP2 does not include a digitizer, the at least one of the first display panel DP1 or the second display panel DP2 may sense an input by the pen PN. Thus, because the digitizer for sensing the pen PN is omitted, an increase in a thickness, an increase in a weight, and a decrease in flexibility of the electronic device 1000 caused by addition of the digitizer may be avoided. Thus, the second display panel DP2 as well as the first display panel DP1 may be designed to sense the pen PN.

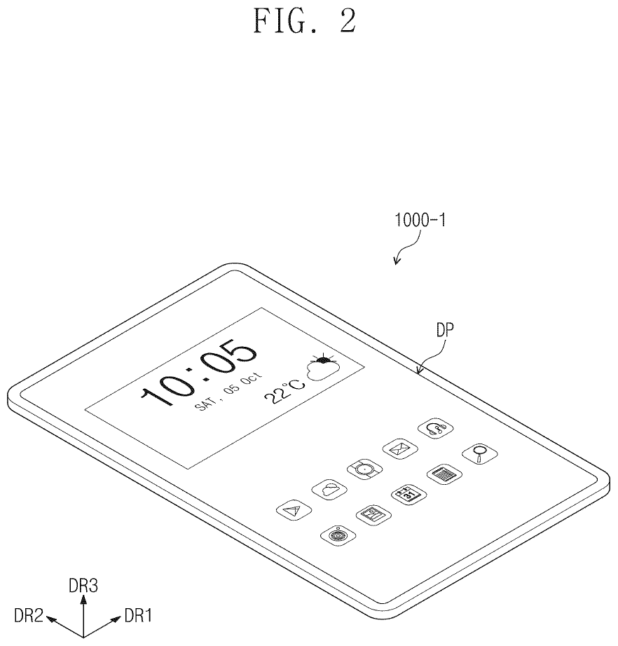

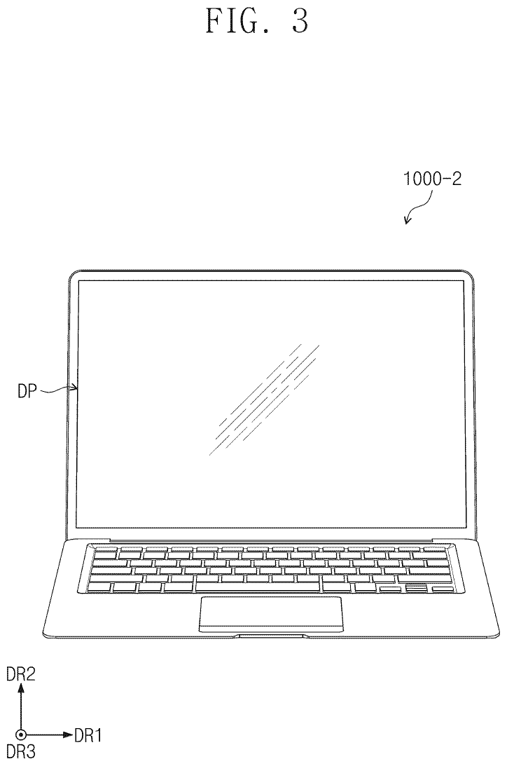

FIG. 2 is a perspective view of an electronic device 1000-1 according to one or more embodiments of the present disclosure. FIG. 3 is a perspective view of an electronic device 1000-2 according to one or more embodiments of the present disclosure.

FIG. 2 illustrates that the electronic device 1000-1 is a portable electronic device (e.g., a mobile phone or a tablet), and the electronic device 1000-1 may include a display panel DP. FIG. 3 illustrates that the electronic device 1000-2 is a laptop, and the electronic device 1000-2 may include the display panel DP. Although FIG. 3 is the perspective view of an electronic device 1000-2, the coordinate axes included in FIG. 3 are displayed based on the display panel DP within the electronic device 1000-2.

In one or more embodiments of the present disclosure, the display panel DP may sense inputs applied from the outside. The external input may be an input of the user. The input of the user may include various types of external inputs, such as the portion of the human body of the user, the pen PN (see FIG. 1A), the light, the heat, or the pressure.

According to one or more embodiments of the present disclosure, the display panel DP may sense an input by the pen PN even when the display panel DP does not include the digitizer. Thus, because the digitizer for sensing the pen PN is omitted, an increase in the thickness and an increase in the weight of the electronic device 1000-1 or 1000-2 caused by the addition of the digitizer may be avoided.

FIG. 1A illustrates the foldable-type electronic device 1000, and FIG. 2 illustrates the bar-type electronic device 1000-1, but the present disclosure described below is not limited thereto. For example, the following descriptions may be applied to various electronic devices, such as a rollable-type electronic device, a slidable-type electronic device, and a stretchable-type electronic device.

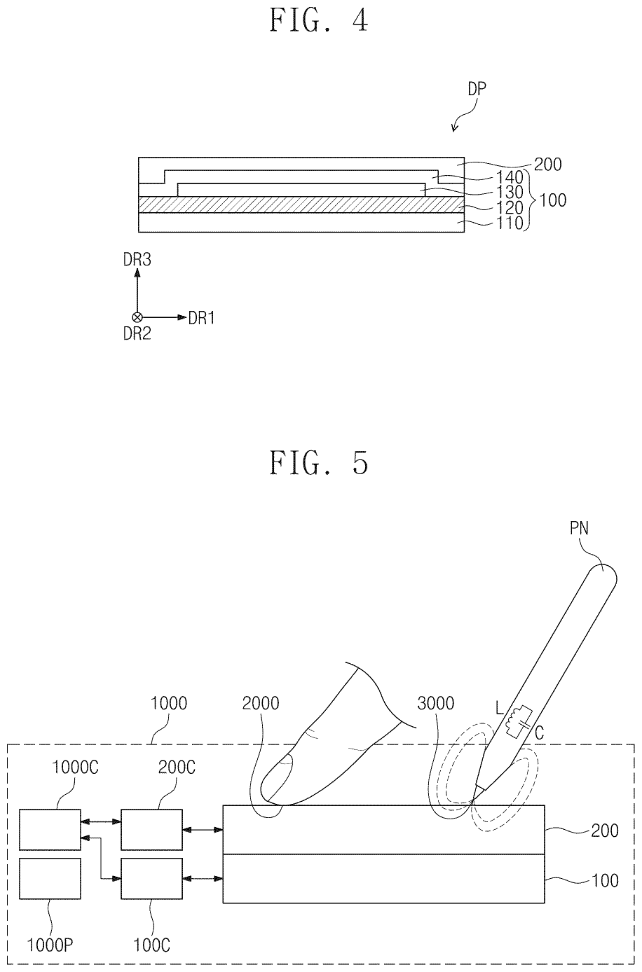

FIG. 4 is a schematic cross-sectional view of the display panel DP according to one or more embodiments of the present disclosure.

Referring to FIG. 4, the display panel DP may include a display layer 100 and a sensor layer 200.

The display layer 100 may be a component that substantially generates an image. The display layer 100 may be a light-emitting display layer. For example, the display layer 100 may be an organic light-emitting display layer, an inorganic light-emitting display layer, an organic-inorganic light-emitting display layer, a quantum dot display layer, a micro-light-emitting diode (LED) display layer, or a nano-LED display layer. The display layer 100 may include a base layer 110, a circuit layer 120, a light-emitting element layer 130, and an encapsulation layer 140.

The base layer 110 may be a member that provides a base surface on which the circuit layer 120 is located. The base layer 110 may have a multi-layer structure or a single-layer structure. The base layer 110 may be a glass substrate, a metal substrate, a silicon substrate, a polymer substrate or the like, but the present disclosure is not for example limited thereto.

The circuit layer 120 may be located on the base layer 110 (as used herein, “located on” may mean “above”). The circuit layer 120 may include an insulating layer, a semiconductor pattern, a conductive pattern, a signal line, and the like. The insulating layer, a semiconductor layer, and a conductive layer may be formed on the base layer 110 in a manner, such as coating and deposition, and the insulating layer, the semiconductor layer, and the conductive layer may be selectively patterned through a plurality of photolithography processes.

The light-emitting element layer 130 may be located on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro-LED, or a nano-LED.

The encapsulation layer 140 may be located on the light-emitting element layer 130. The encapsulation layer 140 may protect the light-emitting element layer 130 from moisture, oxygen, and foreign substances, such as dust particles.

The sensor layer 200 may be located on the display layer 100. The sensor layer 200 may sense an external input applied from an external unit. The sensor layer 200 may be an integrated sensor formed continuously during a process of manufacturing the display layer 100, or the sensor layer 200 may be an external sensor attached to the display layer 100. The sensor layer 200 may be referred to as a sensor, an input-sensing layer, an input-sensing panel, an electronic device for sensing input coordinates, or the like.

According to one or more embodiments of the present disclosure, the sensor layer 200 may sense both inputs for a passive input means, such as the human body of the user, and an input device that generates a magnetic field having a resonant frequency (e.g., predetermined resonant frequency). The input device may be referred to as a pen, an input pen, a magnetic pen, a stylus pen, or an electromagnetic resonance pen.

FIG. 5 is a view for describing an operation of the electronic device 1000 according to one or more embodiments of the present disclosure.

Referring to FIG. 5, the electronic device 1000 may include the display layer 100, the sensor layer 200, a display driver 100C, a sensor driver 200C, a main driver 1000C, and a power circuit 1000P.

The sensor layer 200 may sense a first input 2000 or a second input 3000 applied from an external unit. The first input 2000 and the second input 3000 may be input means that may provide a change in a capacitance of the sensor layer 200, or may be input means that may cause an induced current in the sensor layer 200. For example, the first input 2000 may be a passive-type input means, such as the human body of the user. The second input 3000 may be an input by the pen PN, or may be an input by a radio frequency integrated circuit (RFIC) tag. For example, the pen PN may be a passive pen or an active pen.

In one or more embodiments of the present disclosure, the pen PN may be a device that generates a magnetic field having a resonant frequency (e.g., predetermined resonant frequency). The pen PN may be configured to transmit an output signal based on an electromagnetic resonance method. The pen PN may be referred to as an input device, an input pen, a magnetic pen, a stylus pen, or an electromagnetic resonance pen.

The pen PN may include an RLC resonant circuit, and the RLC resonant circuit may include an inductor L and a capacitor C. In one or more embodiments of the present disclosure, the RLC resonant circuit may be a variable resonant circuit having a variable resonant frequency. In this case, the inductor L may be a variable inductor and/or the capacitor C may be a variable capacitor, but the present disclosure is not for example limited thereto.

The inductor L generates a current by a magnetic field formed in the electronic device 1000, for example, the sensor layer 200. However, the present disclosure is not for example limited thereto. For example, when the pen PN operates as an active type, the pen PN may generate a current even when the pen PN does not receive a magnetic field from an external unit. The generated current is transmitted to the capacitor C. The capacitor C charges a current input from the inductor L and discharges the charged current to the inductor L. Thereafter, the inductor L may emit a magnetic field having a resonant frequency. The induced current may flow in the sensor layer 200 by the magnetic field emitted by the pen PN, and the induced current may be transmitted to the sensor driver 200C as a reception signal (or a sensing signal, or a signal).

The main driver 1000C may control an overall operation of the electronic device 1000. For example, the main driver 1000C may control operations of the display driver 100C and the sensor driver 200C. The main driver 1000C may include at least one microprocessor, and may further include a graphic controller. The main driver 1000C may be referred to as an application processor, a central processing unit, or a main processor.

The display driver 100C may drive the display layer 100. The display driver 100C may receive image data and a control signal from the main driver 1000C. The control signal may include various signals. For example, the control signal may include an input vertical synchronization signal, an input horizontal synchronization signal, a main clock signal, a data enable signal, or the like.

The sensor driver 200C may drive the sensor layer 200. The sensor driver 200C may receive the control signal from the main driver 1000C. The control signal may include a clock signal of the sensor driver 200C. Further, the control signal may further include a mode-determining signal that determines driving modes of the sensor driver 200C and the sensor layer 200.

The sensor driver 200C may be implemented as an integrated circuit IC, and may be electrically connected to the sensor layer 200. For example, the sensor driver 200C may be directly mounted on an area (e.g., predetermined area) of the display panel, or may be mounted on a separate printed circuit board using a chip-on-film (COF) method, and may be electrically connected to the sensor layer 200.

The sensor driver 200C and the sensor layer 200 may be selectively operated in a first mode or a second mode. For example, the first mode may be a mode for sensing a touch input, for example, the first input 2000. The second mode may be a mode for sensing the input by the pen PN, for example, the second input 3000. The first mode may be referred to as a touch-sensing mode, and the second mode may be referred to as a pen-sensing mode.

Switching between the first mode and the second mode may be performed in various manners. For example, the sensor driver 200C and the sensor layer 200 may be driven in the first mode and the second mode in a time division manner, and may sense the first input 2000 and the second input 3000. Alternatively, the switching between the first mode and the second mode may be generated by selection by the user or by a corresponding action (or an input) of the user, any one of the first mode or the second mode may be activated or deactivated by activating or deactivating a corresponding application, or a current mode may be switched from one to the other one of the first mode or the second mode. Alternatively, while the sensor driver 200C and the sensor layer 200 are alternately operated in the first mode and the second mode, when the first input 2000 is sensed, the first mode is maintained, or when the second input 3000 is sensed, the second mode is maintained.

The sensor driver 200C may calculate coordinate information of the input based on a signal received from the sensor layer 200, and may provide a coordinate signal having the coordinate information to the main driver 1000C. The main driver 1000C executes an operation corresponding to the input of the user based on the coordinate signal. For example, the main driver 1000C may operate the display driver 100C so that a new application image is displayed on the display layer 100.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include a gate-high voltage, a gate-low voltage, a first driving voltage (e.g., an ELVSS voltage), a second driving voltage (e.g., an ELVDD voltage), an initialization voltage or the like, but the present disclosure is not for example limited to the above example.

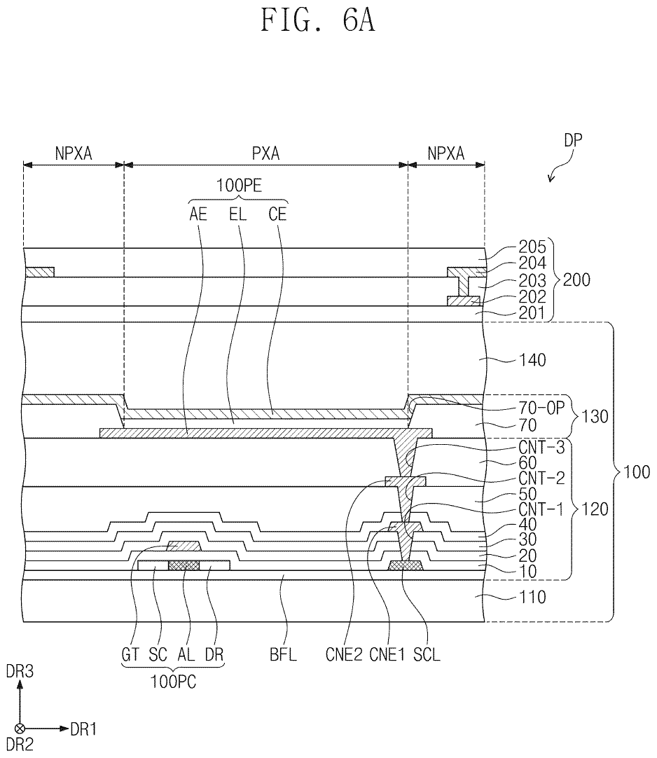

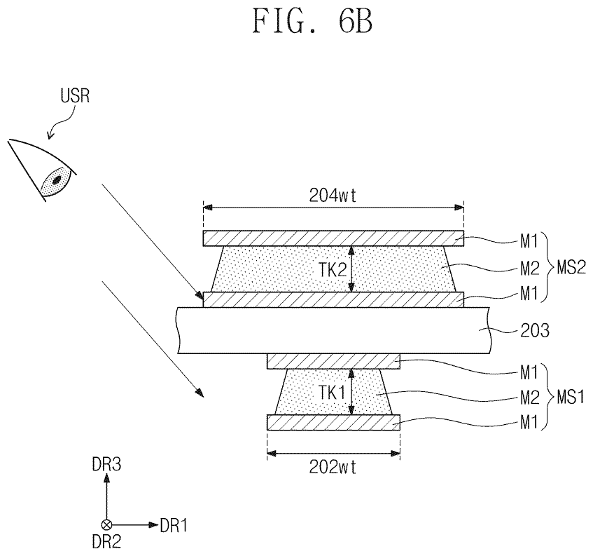

FIG. 6A is a cross-sectional view of the display panel DP according to one or more embodiments of the present disclosure.

Referring to FIG. 6A, at least one buffer layer BFL is formed on an upper surface of the base layer 110. The buffer layer BFL may improve a coupling force between the base layer 110 and the semiconductor pattern. The buffer layer BFL may be formed in multiple layers. Alternatively, the display layer 100 may further include a barrier layer. The buffer layer BFL may include at least one of a silicon oxide, a silicon nitride, or a silicon oxy nitride. For example, the buffer layer BFL may include a structure in which silicon oxide layers and silicon nitride layers are alternately laminated.

Semiconductor patterns SC, AL, DR, and SCL may be arranged on the buffer layer BFL. The semiconductor patterns SC, AL, DR, and SCL may include polysilicon. However, the present disclosure is not limited thereto, and the semiconductor patterns SC, AL, DR, and SCL may also include an amorphous silicon, a low-temperature polycrystalline silicon, or an oxide semiconductor.

FIG. 6A merely illustrates some of the semiconductor patterns SC, AL, DR, and SCL, and the semiconductor pattern may be further arranged in other areas. The semiconductor patterns SC, AL, DR, and SCL may be arranged in a corresponding rule across pixels. The semiconductor patterns SC, AL, DR, and SCL may have different electrical properties depending on whether or not the semiconductor patterns SC, AL, DR, and SCL are doped. The semiconductor patterns SC, AL, DR, and SCL may include the first areas SC, DR, and SCL having high conductivity and the second area AL having low conductivity. The first areas SC, DR, and SCL may be doped with an N-type dopant or a P-type dopant. A P-type transistor may include a doped area doped with the P-type dopant, and an N-type transistor may include a doped area doped with the N-type dopant. The second area AL may be a non-doped area or an area doped at a lower concentration than the first areas SC, DR, and SCL.

A conductivity of the first areas SC, DR, and SCL may be greater than a conductivity of the second area AL, and the first areas SC, DR, and SCL may substantially serve as an electrode or a signal line. The second area AL may substantially correspond to the active area AL (or a channel) of a transistor 100PC. In other words, the portion AL of the semiconductor patterns SC, AL, DR, and SCL may be the active area AL of the transistor 100PC, the other portions SC and DR may be the source area SC or the drain area DR of the transistor 100PC, and the other portion SCL may be a connection electrode or the connection signal line SCL.

Each of pixels may have an equivalent circuit including a plurality of transistors, at least one capacitor, and at least one light-emitting element, and the equivalent circuit of the pixel may be modified into various forms. FIG. 6A illustrates the one transistor 100PC and one light-emitting element 100PE included in the pixel.

The source area SC, the active area AL, and the drain area DR of the transistor 100PC may be formed from the semiconductor patterns SC, AL, DR, and SCL. The source area SC and the drain area DR may extend from the active area AL in opposite directions on a cross section. FIG. 6A illustrates a portion of the connection signal line SCL formed from the semiconductor patterns SC, AL, DR, and SCL. In one or more embodiments, the connection signal line SCL may be connected to the drain area DR of the transistor 100PC on a plane.

A first insulating layer 10 may be located on the buffer layer BFL. The first insulating layer 10 may commonly overlap the plurality of pixels, and may cover the semiconductor patterns SC, AL, DR, and SCL. The first insulating layer 10 may be an inorganic layer and/or an organic layer, and may have a single-layer structure or a multi-layer structure. The first insulating layer 10 may include at least one of an aluminum oxide, a titanium oxide, a silicon oxide, a silicon nitride, a silicon oxy nitride, a zirconium oxide, or a hafnium oxide. In one or more embodiments, the first insulating layer 10 may be a single-layer silicon oxide layer. The first insulating layer 10 and an insulating layer of the circuit layer 120, which will be described below, may be an inorganic layer and/or an organic layer, and may have a single-layer structure or a multi-layer structure. The inorganic layer may include at least one of the above-described materials, but the present disclosure is not limited thereto.

A gate GT of the transistor 100PC is located on the first insulating layer 10. The gate GT may be a portion of a metal pattern. The gate GT overlaps the active area AL. In a process of doping or reducing the semiconductor patterns SC, AL, DR, and SCL, the gate GT may function as a mask.

A second insulating layer 20 may be located on the first insulating layer 10, and may cover the gate GT. The second insulating layer 20 may commonly overlap pixels PX. The second insulating layer 20 may be an inorganic layer and/or an organic layer, and may have a single-layer structure or a multi-layer structure. The second insulating layer 20 may include at least one of a silicon oxide, a silicon nitride, or a silicon oxy nitride. In one or more embodiments, the second insulating layer 20 may have a multi-layer structure including a silicon oxide layer and a silicon nitride layer.

A third insulating layer 30 may be located on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected to the connection signal line SCL through a contact hole CNT-1 passing through the first insulating layer 10, the second insulating layer 20, and the third insulating layer 30.

A fourth insulating layer 40 may be located on the third insulating layer 30. The fourth insulating layer 40 may be a single-layer silicon oxide layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected to the first connection electrode CNE1 through a contact hole CNT-2 passing through the fourth insulating layer 40 and the fifth insulating layer 50.

A sixth insulating layer 60 may be located on the fifth insulating layer 50 to cover the second connection electrode CNE2. The sixth insulating layer 60 may be an organic layer.

The light-emitting element layer 130 may be located on the circuit layer 120. The light-emitting element layer 130 may include the light-emitting element 100PE. For example, the light-emitting element layer 130 may include an organic light-emitting material, an inorganic light-emitting material, an organic-inorganic light-emitting material, a quantum dot, a quantum rod, a micro-LED, or a nano-LED. Hereinafter, it will be described that the light-emitting element 100PE is an organic light-emitting element, but the present disclosure is not for example limited thereto.

The light-emitting element 100PE may include a first electrode AE, a light-emitting layer EL, and a second electrode CE.

The first electrode AE may be located on the sixth insulating layer 60. The first electrode AE may be connected to the second connection electrode CNE2 through a contact hole CNT-3 passing through the sixth insulating layer 60.

A pixel-defining film 70 may be located on the sixth insulating layer 60, and may cover a portion of the first electrode AE. An opening 70-OP is defined in the pixel-defining film 70. The opening 70-OP of the pixel-defining film 70 exposes at least a portion of the first electrode AE.

The first display part DA1-F (see FIG. 1A) may include a light-emitting area PXA, and a non-light-emitting area NPXA adjacent to the light-emitting area PXA. The non-light-emitting area NPXA may surround the light-emitting area PXA. In one or more embodiments, the light-emitting area PXA is defined to correspond to a partial area of the first electrode AE, which is exposed by the opening 70-OP.

The light-emitting layer EL may be located on the first electrode AE. The light-emitting layer EL may be located in an area corresponding to the opening 70-OP. FIG. 6A illustrates that the light-emitting layer EL is located inside the opening 70-OP, but the present disclosure is not for example limited thereto. For example, the light-emitting layer EL may extend to cover portions of a side surface of the pixel-defining film 70, which defines the opening 70-OP, and an upper surface of the pixel-defining film 70.

In one or more embodiments of the present disclosure, the light-emitting layer EL may be formed separately from each of the pixels. When the light-emitting layer EL is formed separately from each of the pixels, each of the light-emitting layers EL may emit a light having at least one of a blue color, a red color, or a green color. However, the present disclosure is not limited thereto, and the light-emitting layer EL may have an integral shape, and may be commonly included in the plurality of pixels. In this case, the light-emitting layer EL may also provide a blue light or a white light.

The second electrode CE may be located on the light-emitting layer EL. The second electrode CE may have an integral shape, and may be commonly included in the plurality of pixels.

In one or more embodiments of the present disclosure, a hole control layer may be located between the first electrode AE and the light-emitting layer EL. The hole control layer may be commonly located in the light-emitting area PXA and the non-light-emitting area NPXA. The hole control layer may include a hole transport layer, and may further include a hole injection layer. An electron control layer may be located between the light-emitting layer EL and the second electrode CE. The electron control layer may include an electron transport layer, and may further include an electron injection layer. The hole control layer and the electron control layer may be commonly formed in the plurality of pixels by using an open mask or an inkjet process.

The encapsulation layer 140 may be located on the light-emitting element layer 130. The encapsulation layer 140 may include an inorganic layer, an organic layer, and an inorganic layer that are sequentially laminated, but layers constituting the encapsulation layer 140 are not limited thereto. The inorganic layers may protect the light-emitting element layer 130 from moisture and oxygen, and the organic layer may protect the light-emitting element layer 130 from foreign substances, such as dust particles. The inorganic layers may include a silicon nitride layer, a silicon oxy nitride layer, a silicon oxide layer, a titanium oxide layer, an aluminum oxide layer or the like. The organic layer may include an acryl-based organic layer, and the present disclosure is not limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least one of a silicon nitride, a silicon oxy nitride, or a silicon oxide. Alternatively, the base layer 201 may be an organic layer including an epoxy resin, an acryl-based resin, or an imide-based resin. The base layer 201 may have a single-layer structure, or have a multi-layer structure in which layers are laminated in the third direction DR3. In one or more embodiments of the present disclosure, the sensor layer 200 may not include the base layer 201.

Each of the first conductive layer 202 and the second conductive layer 204 may have a single-layer structure or have a multi-layer structure in which layers are laminated in the third direction DR3.

Each of the first conductive layer 202 and the second conductive layer 204 having a single-layer structure may include a metal layer or a transparent conductive layer. The metal layer may include molybdenum, silver, titanium, copper, aluminum, or alloys thereof. The transparent conductive layer may include a transparent conductive oxide, such as an indium tin oxide (ITO), an indium zinc oxide (IZO), a zinc oxide (ZnO), or an indium zinc tin oxide (IZTO). In addition, the transparent conductive layer may include a conductive polymer, such as poly(3,4-ethylenedioxythiophene) (PEDOT), a metal nanowire, graphene, or the like.

Each of the first conductive layer 202 and the second conductive layer 204 having a multi-layer structure may include metal layers. The metal layers may have, for example, a three-layer structure of titanium/aluminum/titanium. The conductive layer having a multi-layer structure may include at least one metal layer and at least one transparent conductive layer.

In one or more embodiments of the present disclosure, a thickness of the first conductive layer 202 may be greater than or equal to a thickness of the second conductive layer 204. When the thickness of the first conductive layer 202 is greater than the thickness of the second conductive layer 204, a resistance of a component (e.g., an electrode, a pattern, a bridge pattern, or the like) included in the first conductive layer 202 may be decreased. Further, because the first conductive layer 202 is located under the second conductive layer 204, even when the thickness of the first conductive layer 202 is increased, a probability that components included in the first conductive layer 202 are visually recognized due to reflection of an external light may be decreased.

At least one of the intermediate insulating layer 203 or the cover insulating layer 205 may include an inorganic film. The inorganic film may include at least one of an aluminum oxide, a titanium oxide, a silicon oxide, a silicon nitride, a silicon oxy nitride, a zirconium oxide, or a hafnium oxide.

At least one of the intermediate insulating layer 203 or the cover insulating layer 205 may include an organic film. The organic film may include at least one of an acryl-based resin, a methacrylate-based resin, a polyisoprene-based resin, a vinyl-based resin, an epoxy-based resin, a urethane-based resin, a cellulose-based resin, a siloxane-based resin, a polyimide-based resin, a polyamide-based resin, or a perylene-based resin.

The fact that the sensor layer 200 includes the first conductive layer 202 and the second conductive layer 204, that is, a total of two conductive layers, has been described above, but the present disclosure is not for example limited thereto. For example, the sensor layer 200 may include three or more conductive layers.

FIG. 6B is a cross-sectional view illustrating some components of the sensor layer 200 (see FIG. 6A) according to one or more embodiments of the present disclosure.

Referring to FIGS. 6A and 6B, a second width 204wt of a second mesh line MS2 included in the second conductive layer 204 may be greater than or equal to a first width 202wt of a first mesh line MS1 included in the first conductive layer 202. When a user USR views the first mesh line MS1 and the second mesh line MS2 from a side surface, the first mesh line MS1 has a width that is less than that of the second mesh line MS2, and thus a probability that the first mesh line MS1 is visually recognized by the user USR may be decreased.

Each of the first mesh line MS1 and the second mesh line MS2 may include first metal layers M1, and a second metal layer M2 located between the first metal layers M1. For example, the first metal layers M1 may include titanium (Ti), and the second metal layer M2 may include aluminum (Al). However, this is merely an example, and the present disclosure is not for example limited thereto.

In one or more embodiments of the present disclosure, a first thickness TK1 of the second metal layer M2 of the first mesh line MS1 may be substantially the same as a second thickness TK2 of the second metal layer M2 of the second mesh line MS2, but the present disclosure is not for example limited thereto. For example, the first thickness TK1 may be greater than the second thickness TK2. Alternatively, the second thickness TK2 may be greater than the first thickness TK1. In one or more embodiments of the present disclosure, each of the first thickness TK1 and the second thickness TK2 may be about 1,000 Å or more, and for example, may be about 6,000 Å.

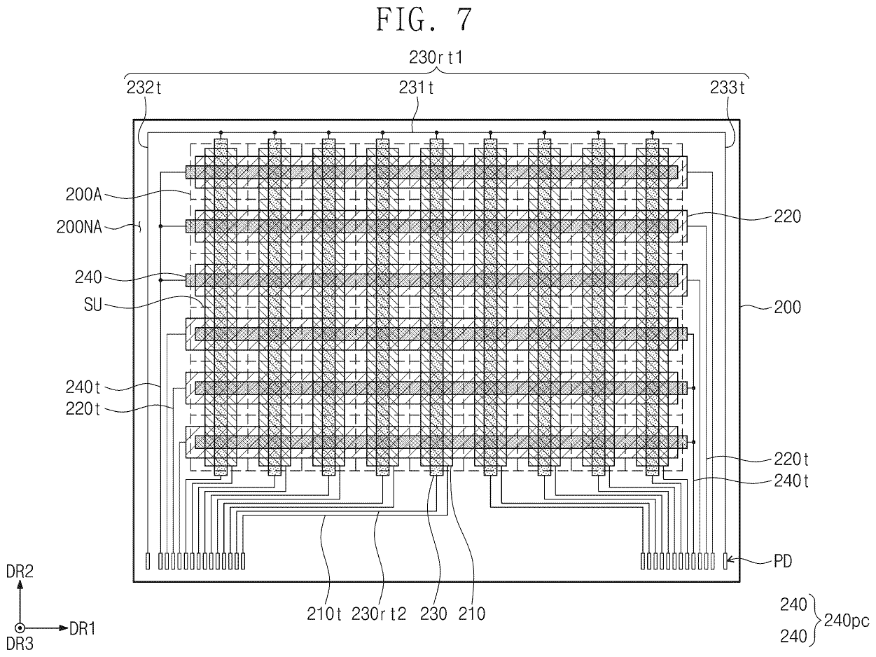

FIG. 7 is a plan view of the sensor layer 200 according to one or more embodiments of the present disclosure.

Referring to FIG. 7, a sensing area 200A, and a peripheral area 200NA adjacent to the sensing area 200A, may be defined in the sensor layer 200.

The sensor layer 200 may include a plurality of first electrodes 210, a plurality of second electrodes 220, a plurality of third electrodes 230, and a plurality of fourth electrodes 240, which are arranged in the sensing area 200A. In one or more embodiments of the present disclosure, the fourth electrodes 240 may be omitted.

The first electrodes 210 may cross the second electrodes 220. Each of the first electrodes 210 may extend in the second direction DR2, and the first electrodes 210 may be spaced apart from each other in the first direction DR1. Each of the second electrodes 220 may extend in the first direction DR1, and the second electrodes 220 may be spaced apart from each other in the second direction DR2. A sensing unit SU of the sensor layer 200 may be an area in which the one first electrode 210 and the one second electrode 220 cross each other.

FIG. 7 illustrates nine first electrodes 210 and six second electrodes 220, and illustrates 54 sensing units SU, but the number of first electrodes 210 and the number of second electrodes 220 are not limited thereto.

Each of the third electrodes 230 may extend in the second direction DR2, and the third electrodes 230 may be spaced apart from each other in the first direction DR1. The one third electrode 230 may at least partially overlap the one first electrode 210. According to one or more embodiments of the present disclosure, an overlapping area between the one first electrode 210 and the one third electrode 230 may be adjusted to adjust a capacitance (or a coupling capacitance) between the one first electrode 210 and the one third electrode 230.

The fourth electrodes 240 may be arranged in the second direction DR2, and the fourth electrodes 240 may extend in the first direction DR1. The one fourth electrode 240 may at least partially overlap the one second electrode 220. According to one or more embodiments of the present disclosure, an overlapping area between the one second electrode 220 and the one fourth electrode 240 may be adjusted to adjust a capacitance (or a coupling capacitance) between the one second electrode 220 and the one fourth electrode 240.

In one or more embodiments of the present disclosure, at least some of the fourth electrodes 240 may be electrically connected to each other to constitute one electrode group 240pc. For example, in FIG. 7, the three fourth electrodes 240 form one electrode group 240pc, and one electrode group 240pc may be connected to the same one trace line, such as the fourth trace line 240t. Thus, FIG. 7 illustrates that the two electrode groups 240pc are arranged in the second direction DR2. However, the number of fourth electrodes 240 constituting the one electrode group 240pc is not limited thereto. For example, the number of fourth electrodes 240 constituting the one electrode group 240pc may be six, and in this case, the sensor layer 200 may include only the one electrode group 240pc.

The sensor layer 200 may further include a plurality of first trace lines 210t and a plurality of second trace lines 220t arranged in the peripheral area 200NA. The first trace lines 210t may be electrically connected to the first electrodes 210 in one-to-one correspondence. The second trace lines 220t may be electrically connected to the second electrodes 220 in one-to-one correspondence.

The sensor layer 200 may further include a third trace line 230rt1, the fourth trace lines 240t, and fifth trace lines 230rt2 arranged in the peripheral area 200NA.

The third trace line 230rt1 may be electrically connected to the third electrodes 230. In one or more embodiments of the present disclosure, the third trace line 230rt1 may be electrically connected to all of the third electrodes 230. The third trace line 230rt1 may include a first line portion 231t extending in the first direction DR1 and electrically connected to the third electrodes 230, a second line portion 232t extending from a first end of the first line portion 231t in the second direction DR2, and a third line portion 233t extending from a second end of the first line portion 231t in the second direction DR2.

In one or more embodiments of the present disclosure, a resistance of the second line portion 232t and a resistance of the third line portion 233t each may be substantially equal to or lower than a resistance of the one of the third electrodes 230. Thus, the second line portion 232t and the third line portion 233t may serve as the third electrodes 230, and the same aspect may be obtained as if the third electrodes 230 are also arranged in the peripheral area 200NA. For example, a coil including at least one of the second line portion 232t or the third line portion 233t maybe formed. Thus, the pen positioned in an area adjacent to the peripheral area 200NA may also be sufficiently charged by a loop including the second line portion 232t or the third line portion 233t.

In one or more embodiments of the present disclosure, a width of each of the second line portion 232t and the third line portion 233t in the first direction DR1 may be adjusted to adjust the resistance of the second line portion 232t and the resistance of the third line portion 233t. However, this is merely an example, and the first line portion 231t, the second line portion 232t, and the third line portion 233t may have substantially the same width.

The fifth trace lines 230rt2 may be connected to the third electrodes 230 in one-to-one correspondence. That is, the number of fifth trace lines 230rt2 may correspond to the number of third electrodes 230. FIG. 7 illustrates nine fifth trace lines 230rt2 and nine third electrodes 230.

According to one or more embodiments of the present disclosure, the third electrodes 230, the second line portion 232t, and the third line portion 233t may be referred to as charging electrodes. Ends of the third electrodes 230, the second line portion 232t, and the third line portion 233t may be connected to the first line portion 231t, and the other ends of the third electrodes 230, the second line portion 232t, and the third line portion 233t may be selectively connected by binder circuits, which will be described below. That is, the third electrodes 230, the second line portion 232t, and the third line portion 233t that constitute a charging loop may be varied. In this case, a charging operation may be subdivided, and accordingly, a position of the charging loop may be finely adjusted, and a resistance of the charging loop may be suitably adjusted. As a result, charging efficiency and charging sensitivity of the pen PN (see FIG. 5) charged by a magnetic field provided from the charging loop may be improved. Further, the charging efficiency and the charging sensitivity of the pen PN are improved, and thus, a response speed between the pen PN and the sensor layer 200 may be improved.

The fourth trace lines 240t may be spaced apart from each other with the sensing area 200A interposed therebetween. The fourth trace lines 240t may be electrically connected to the electrode groups 240pc in one-to-one correspondence. FIG. 7 illustrates that the two electrode groups 240pc are arranged. The fourth trace line 240t connected to the one electrode group 240pc, and the fourth trace line 240t connected to the other one electrode group 240pc, may be spaced apart from each other with the sensing area 200A interposed therebetween. However, the present disclosure is not for example limited thereto.

The sensor layer 200 may include a plurality of pads PD arranged in the peripheral area 200NA. The pads PD may be spaced apart from each other in the first direction DR1. FIG. 7 illustrates that the pads PD are arranged in one row in the first direction DR1, but the present disclosure is not for example limited thereto. For example, the pads PD may be arranged in a plurality of rows.

The pads PD may be electrically connected to the first trace lines 210t, the second trace lines 220t, one end of the second line portion 232t of the third trace line 230rt1, one end of the third line portion 233t of the third trace line 230rt1, the fourth trace lines 240t, and the fifth trace lines 230rt2 in one-to-one correspondence as described above.

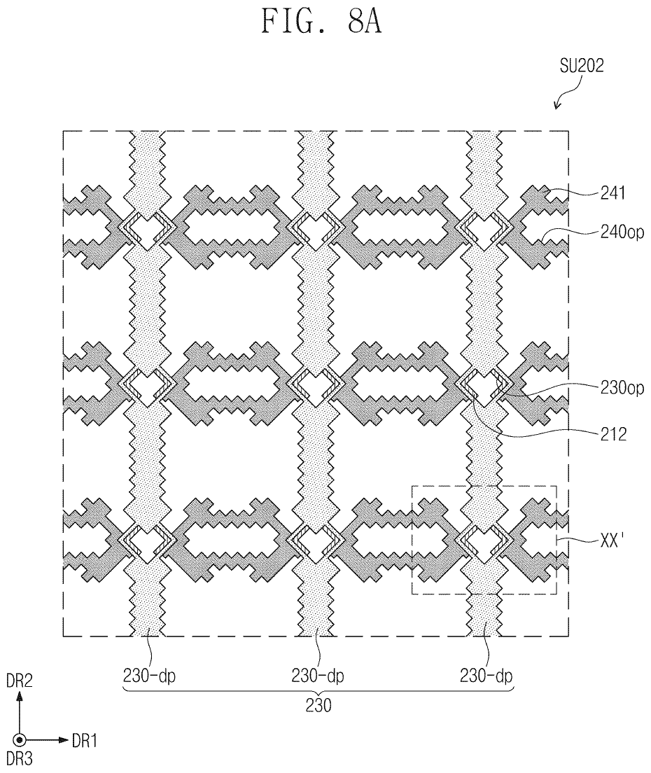

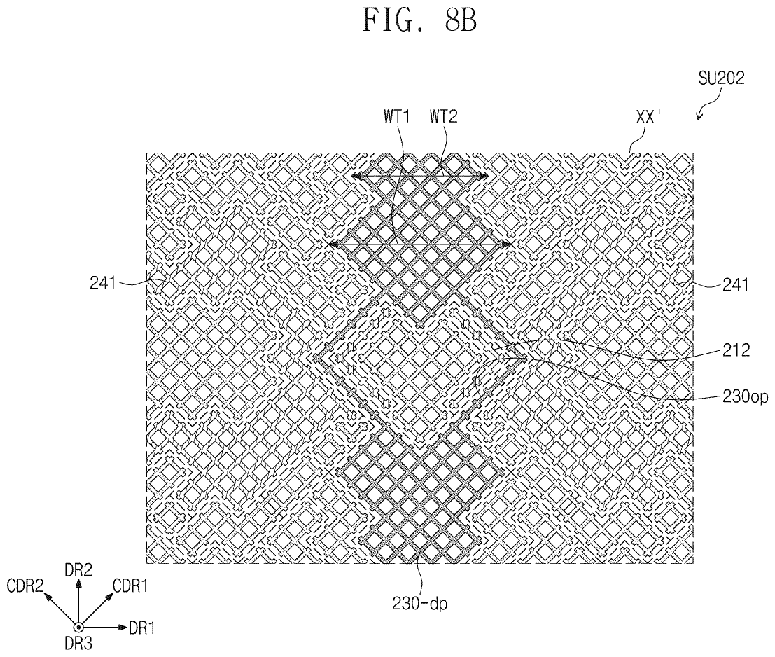

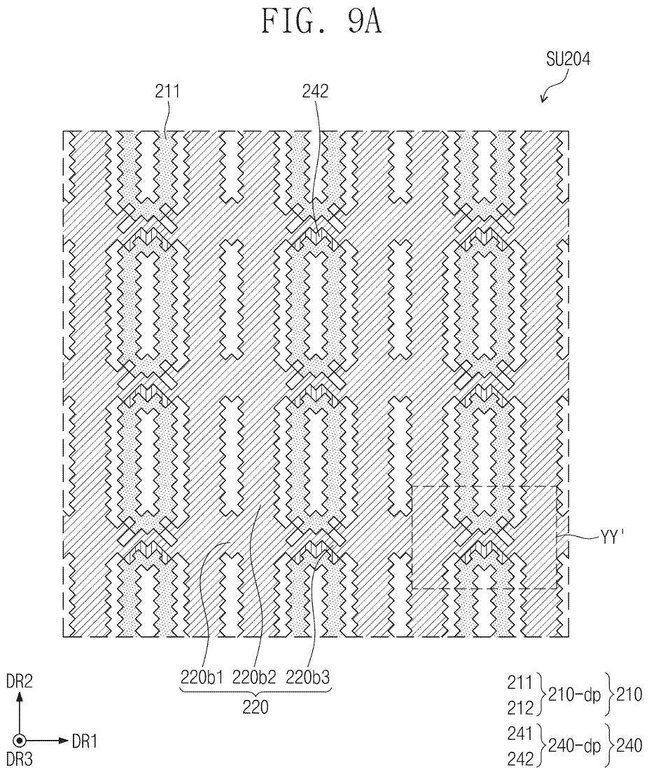

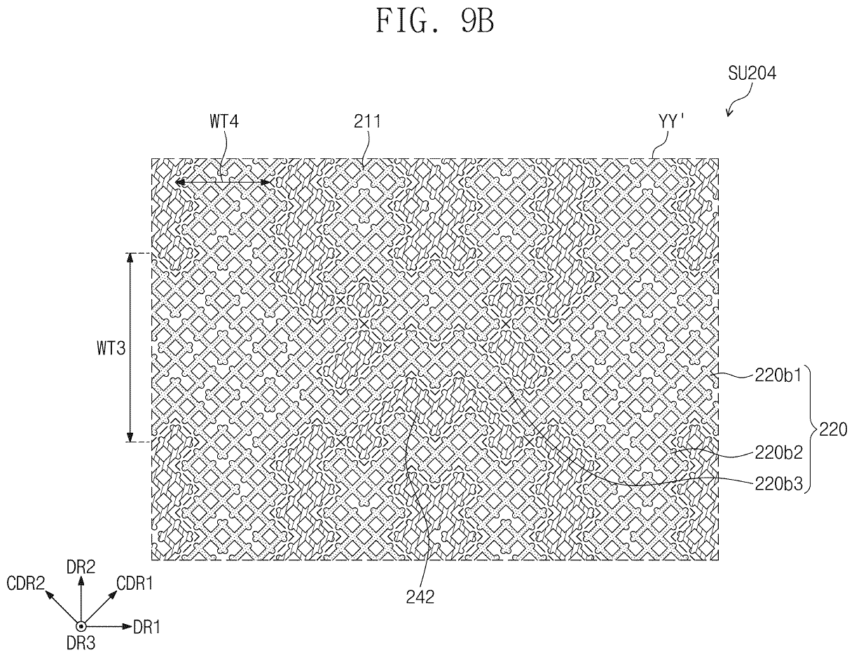

FIG. 8A is a plan view illustrating a first conductive layer SU202 of the sensing unit SU (see FIG. 7) according to one or more embodiments of the present disclosure. FIG. 8B is an enlarged plan view of an area XX′ illustrated in FIG. 8A. FIG. 9A is a plan view illustrating a second conductive layer SU204 of the sensing unit SU (see FIG. 7) according to one or more embodiments of the present disclosure. FIG. 9B is an enlarged plan view of an area YY′ illustrated in FIG. 9A.

FIGS. 8A and 9A do not illustrate a shape of a mesh structure, and briefly illustrate boundaries of respective components using lines. That is, it may be understood that the lines illustrated in FIGS. 8A and 9A correspond to cutting lines obtained by cutting a mesh structure illustrated in FIGS. 8B and 9B, and FIGS. 8B and 9B illustrate the cutting lines using dotted lines.

A shape of the sensing unit SU illustrated in FIGS. 7, 8A, 8B, 9A, and 9B is merely an example, and the present disclosure is not limited thereto. The shape of the sensing unit SU may be variously modified.

Referring to FIGS. 7, 8A, 8B, 9A, and 9B, the first electrode 210 may include a plurality of first segmented electrodes 210-dp spaced apart from each other in the first direction DR1. Each of the first segmented electrodes 210-dp may include a plurality of first patterns 211, and a plurality of first bridge patterns 212 electrically connected to the first patterns 211. The first patterns 211, which are spaced apart from each other in the second direction DR2, may be electrically connected by the first bridge patterns 212. Thus, each of the first segmented electrodes 210-dp may extend in the second direction DR2, and the first segmented electrodes 210-dp may be spaced apart from each other in the first direction DR1.

The third electrode 230 may include a plurality of second segmented electrodes 230-dp spaced apart from each other in the first direction DR1. Each of the second segmented electrodes 230-dp may extend in the second direction DR2.

When viewed in the third direction DR3, the second segmented electrodes 230-dp may overlap the first segmented electrodes 210-dp in one-to-one correspondence. The wording “overlapping” may also mean that at least a portion of the one first segmented electrode 210-dp and at least a portion of the one second segmented electrode 230-dp overlap each other.

FIGS. 8A and 9A illustrate that the one sensing unit SU includes the three first segmented electrodes 210-dp and the three second segmented electrodes 230-dp, but the present disclosure is not for example limited thereto. For example, the number of first segmented electrodes 210-dp and the number of second segmented electrodes 230-dp included in the one sensing unit SU may be one, two, or four or more. Each of the first segmented electrodes 210-dp and the second segmented electrodes 230-dp may correspond to a resistance path or a signal transmitting path through which a signal is transmitted.

Referring to FIGS. 7 and 8A together, the one fifth trace line 230rt2 may be electrically connected to the one third electrode 230. In this case, the one fifth trace line 230rt2 may be electrically connected to three second segmented electrodes 230-dp. In this case, a degree to which the number of pads inside the sensor layer 200 is increased may be decreased.

As compared to a case in which the first electrode 210 inside the one sensing unit SU is not divided and has a single shape, when the first electrode 210 inside the one sensing unit SU includes the first segmented electrodes 210-dp, the first segmented electrodes 210-dp may be arranged inside the one sensing unit SU in a relatively uniform distribution. In this case, the signal may be uniformly provided or sensed inside the one sensing unit SU.

Further, as compared to a case in which the first electrode 210 inside the one sensing unit SU is not divided, when the first electrode 210 inside the one sensing unit SU includes the first segmented electrodes 210-dp, the number of first bridge patterns 212 inside the one sensing unit SU may increase. FIG. 8A illustrates that, when the two first bridge patterns 212 connected to the same two first patterns 211 are considered as a pair, nine pairs of first bridge patterns 212 are arranged. That is, a total of 18 first bridge patterns 212 are illustrated.

For example, an increase in the number of first bridge patterns 212 arranged in the first direction DR1 crossing the second direction DR2 that is an extension direction of the first electrode 210 may correspond to an increase in a signal path. Thus, as the number of signal paths is increased, a resistance of the first electrode 210 may be decreased. As a result, sensing sensitivity of the sensor layer 200 may be improved.

Further, the shape of each of the first segmented electrodes 210-dp may be similar to a bar shape extending in the second direction DR2, and as the shape is more similar to the bar shape, a path of the resistance path may be shortened. Thus, when the path of the resistance path is shortened, and the number of resistance paths connected in parallel inside the one first electrode 210 is increased, the resistance of the first electrode 210 may be decreased. As a result, the sensing sensitivity of the sensor layer 200 may be improved.

Further, as the shape of each of the first segmented electrodes 210-dp is more similar to the bar shape extending in the second direction DR2, a ratio of an area that may be used in pattern design inside the entire area of the one sensing unit SU may be increased. Thus, the degree of freedom in the pattern design may be improved.

According to one or more embodiments of the present disclosure, the degree of freedom in the pattern design of the sensing unit SU may be improved, and the resistance of the electrode included in the sensing unit SU may be decreased. In this case, a frequency range (e.g., a bandwidth) applicable to the signal provided to the sensor layer 200 may be more advantageously secured. Thus, the degree of freedom in selecting a frequency may be improved.

According to one or more embodiments of the present disclosure, each of the first patterns 211 may have a ring shape, and a portion of each of the second segmented electrodes 230-dp, which overlaps the first patterns 211, may be similar to a bar shape. In this case, an overlapping area between the first electrode 210 and the third electrode 230 may be suitably adjusted by adjusting a size of an inner diameter of each of the first patterns 211, a width of each of the second segmented electrodes 230-dp, or the like.

According to one or more embodiments of the present disclosure, the first segmented electrode 210-dp may include the first patterns 211 and the first bridge patterns 212 arranged on different layers, and the first patterns 211 and the first bridge patterns 212 may be electrically connected through contact. In this case, the resistance may be relatively increased as compared to a case in which the first patterns 211 and the first bridge patterns 212 are arranged on the same layer and are integrally provided.

In one or more embodiments of the present disclosure, a resistance of a portion of the second segmented electrode 230-dp, which overlaps the first pattern 211, may be lower than a resistance of the first pattern 211. However, this is merely an example, and a resistance relationship may be changed depending on a width of the ring of the first pattern 211 or a size of a width of the portion of the second segmented electrode 230-dp.

The second segmented electrode 230-dp may extend in the second direction DR2 inside the same layer. Thus, the resistance due to layer change inside the second segmented electrode 230-dp may not be increased. The second segmented electrode 230-dp may be an electrode to which a signal is applied in a charging drive mode, which will be described below. Thus, as the resistance of the second segmented electrode 230-dp is decreased, the intensities of a current and a magnetic field for charging a resonant circuit of the pen PN (see FIG. 5) may be increased.

According to one or more embodiments of the present disclosure, because the portion of each of the second segmented electrodes 230-dp, which overlaps the first patterns 211, is similar to the bar shape, the second segmented electrode 230-dp may have a shape of which a width is relatively less than that of the first segmented electrode 210-dp. In this case, a parasitic capacitance caused in each of the second segmented electrodes 230-dp may be decreased. Thus, performance of the sensor layer 200 may be improved.

Referring to FIG. 8B, the second segmented electrode 230-dp may include a first portion having a first width WT1 in the first direction DR1, and a second portion having a second width WT2 in the first direction DR1. The first width WT1 may be greater than the second width WT2. For example, the first portion having the first width WT1 may be closer to the first bridge patterns 212 than the second portion having the second width WT2.

On a plane, the first portion having the first width WT1 may overlap the first patterns 211 to form a capacitance. Further, the second portion having the second width WT2 may overlap a dummy pattern surrounded by the first patterns 211. The overlapping area between the first electrode 210 and the third electrode 230 may be suitably adjusted by adjusting the second width WT2.

An opening 230op may be defined in the second segmented electrode 230-dp, and the two first bridge patterns 212 may be arranged in the opening 230op. When the first bridge patterns 212 are surrounded by the second segmented electrode 230-dp, capacitances having values that change depending on temperatures among capacitances generated in the first electrode 210 may be decreased. Thus, temperature characteristics of the sensor layer 200 may be improved.

The second electrode 220 may include a plurality of first branch portions 220b1 extending in the first direction, a plurality of second branch portions 220b2 extending in the second direction DR2 crossing the first direction DR1, and a connection portion 220b3 located between the first patterns 211. The first branch portions 220b1 may be spaced apart from each other in the second direction DR2, and the second branch portions 220b2 may be spaced apart from each other in the first direction DR1. The first branch portions 220b1, the second branch portions 220b2, and the connection portion 220b3 may be connected to each other to have an integral shape.

The fourth electrode 240 may include a plurality of third segmented electrodes 240-dp spaced apart from each other in the second direction DR2. Each of the third segmented electrodes 240-dp may extend in the first direction DR1. Each of the third segmented electrodes 240-dp may include a plurality of second patterns 241, and a plurality of second bridge patterns 242 electrically connected to the second patterns 241. Each of the second patterns 241 may have a ring shape. The second patterns 241 and the second bridge patterns 242 may be electrically connected to each other through contact holes defined in the intermediate insulating layer 203 (see FIG. 6A). The two adjacent second patterns 241 may be spaced apart from each other with the one second segmented electrode 230-dp and the two first bridge patterns 212 interposed therebetween.

In one or more embodiments of the present disclosure, a third width WT3 of the first branch portions 220b1 in the second direction DR2 may be greater than a fourth width WT4 of the second branch portions 220b2 in the first direction DR1. For example, the first branch portions 220b1 may overlap both the second patterns 241 and a dummy pattern surrounded by the second patterns 241. An overlapping area between the second electrode 220 and the fourth electrode 240 may be suitably adjusted by adjusting the third width WT3. Alternatively, the overlapping area between the second electrode 220 and the fourth electrode 240 may be suitably adjusted by adjusting a size of an inner diameter of the ring shape surrounding the dummy pattern of each of the second patterns 241.

In one or more embodiments of the present disclosure, each of the third segmented electrodes 240-dp may include the second patterns 241 and the second bridge patterns 242 arranged on different layers, and the second patterns 241 and the second bridge patterns 242 may be electrically connected through contact. In this case, the resistance may be relatively increased as compared to a case in which the second patterns 241 and the second bridge patterns 242 are arranged on the same layer and integrally provided.

In one or more embodiments of the present disclosure, the third electrode 230 corresponds to a configuration that transmits a signal when a pen is sensed, and the fourth electrode 240 corresponds to a configuration that forms a capacitance with the third electrode 230 when the pen is sensed. Thus, it is more appropriate to reduce a resistance of the third electrode 230 than to reduce a resistance of the fourth electrode 240. Thus, the third electrode 230 may be implemented in the same one layer, and the fourth electrode 240 may be implemented in two different layers.

Referring to FIGS. 8B and 9B, the second bridge pattern 242 may include only one line extending in a first intersection direction CDR1 and/or a second intersection direction CDR2 in a partial section. In this case, the first bridge pattern 212 overlapping the second bridge pattern 242 may be insulated from, and may cross, the second bridge pattern 242 in the partial section. In this case, a capacitance between the first bridge pattern 212 and the second bridge pattern 242 may be reduced or minimized.

Referring to FIGS. 8B and 9B, each of the second segmented electrodes 230-dp, the second patterns 241, the first patterns 211, the second electrode 220, and the second bridge patterns 242 may have a mesh structure. Each of the mesh structures may include a plurality of mesh lines. Each of the plurality of mesh lines may have a shape extending in a direction (e.g., predetermined direction), and the mesh lines may be connected to each other. The shape may be various shapes, such as a straight line, a line having a protrusion, and/or an uneven line. Openings at least partially surrounded by the mesh lines may be defined (provided or formed) in each of the mesh structures. The openings may overlap the light-emitting area PXA (see FIG. 6A), and the mesh lines may overlap the non-light-emitting area NPXA (see FIG. 6A). However, the present disclosure is not for example limited thereto.

FIGS. 8B and 9B illustrate that the mesh structure includes mesh lines extending in the first intersection direction CDR1 that crosses the first direction DR1 and the second direction DR2, and mesh lines extending in the second intersection direction CDR2 that crosses the first intersection direction CDR1. However, the extension directions of the mesh lines constituting the mesh structure are not for example limited to the illustration of FIGS. 8B and 9B. For example, the mesh structure may include only mesh lines extending in the first direction DR1 and the second direction DR2, or may include mesh lines extending in the first direction DR1, the second direction DR2, the first intersection direction CDR1, and the second intersection direction CDR2. That is, the mesh structure may be changed into various forms.

In one or more embodiments of the present disclosure, a first capacitance may be defined between the first electrode 210 and the third electrode 230, and a second capacitance may be defined between the second electrode 220 and the fourth electrode 240. A magnitude of the first capacitance and a magnitude of the second capacitance may be adjusted by the overlapping area between the first electrode 210 and the third electrode 230, and by the overlapping area between the second electrode 220 and the fourth electrode 240.

As the first capacitance and the second capacitance are increased, the amount of induced current transmitted from the third electrode 230 to the first electrode 210 may be increased, and the amount of induced current transmitted from the fourth electrode 240 to the second electrode 220 may be increased. Thus, as the first capacitance and the second capacitance are increased, pen-sensing performance of the sensor layer 200 may be improved. Further, the first capacitance and the second capacitance may act as loads during touch sensing. Thus, as the first capacitance and the second capacitance are decreased, touch-sensing performance may be improved.

According to the present disclosure, the overlapping area between the first electrode 210 and the third electrode 230, and the overlapping area between the second electrode 220 and the fourth electrode 240, may be suitably adjusted. Thus, the sensor layer 200 having appropriate capacitances considering touch sensitivity and pen-sensing sensitivity may be provided. As a result, the electronic device 1000 (see FIG. 1A) having both improved pen sensitivity and improved touch sensitivity may be provided.

In one or more embodiments of the present disclosure, in the second conductive layer SU204 inside the one sensing unit SU, an area occupied by components included in the first electrode 210 and the second electrode 220 may be greater than an area occupied by components included in the third electrode 230 and the fourth electrode 240. A change in the capacitance due to the first input 2000 (see FIG. 4) may be greater as a distance therefrom becomes shorter. Thus, components for sensing the first input 2000 (see FIG. 4) may be arranged in a relatively larger area in a layer adjacent to a surface of the electronic device 1000 (see FIG. 1A). As a result, touch performance may be improved.

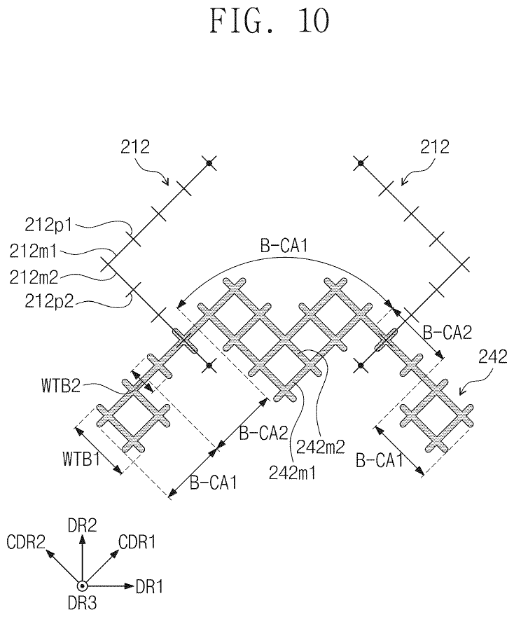

FIG. 10 is a plan view illustrating some components of the sensing unit according to one or more embodiments of the present disclosure.

FIG. 10 illustrates the one second bridge pattern 242, and the two first bridge patterns 212 overlapping the one second bridge pattern 242.

Each of the first bridge patterns 212 may include a first main line 212m1 extending in the first intersection direction CDR1, and a second main line 212m2 extending in the second intersection direction CDR2. One end of the first main line 212m1 and one end of the second main line 212m2 may cross each other. The first bridge pattern 212 may further include a plurality of first protrusion lines 212p1 crossing the first main line 212m1 and a plurality of second protrusion lines 212p2 crossing the second main line 212m2. The first protrusion lines 212p1 may be spaced apart from each other in the first intersection direction CDR1, and the second protrusion lines 212p2 may be spaced apart from each other in the second intersection direction CDR2. In one or more embodiments of the present disclosure, the first protrusion lines 212p1 and the second protrusion lines 212p2 may be omitted.

The second bridge pattern 242 may include first lines 242m1 extending in the first intersection direction CDR1, and second lines 242m2 extending in the second intersection direction CDR2. According to one or more embodiments of the present disclosure, the second bridge pattern 242 may include first portions B-CA1 in which the two or more first lines 242m1 and the two or more second lines 242m2 cross each other, and also may include second portions B-CA2 in which the one first line 242m1 and the one or more second lines 242m2 cross each other, or in which the one or more first lines 242m1 and the one second line 242m2 cross each other. The second portions B-CA2 may cross the first bridge patterns 212, respectively.

In one or more embodiments of the present disclosure, each of the first portions B-CA1 may include at least two lines extending in a corresponding direction, and each of the second portions B-CA2 may include only one line extending in the same direction. Thus, a first minimum width WTB1 of the first portions B-CA1 may be greater than a second minimum width WTB2 of the second portions B-CA2.

The first bridge patterns 212 overlapping the second bridge patterns 242 may be insulated from, and may cross, the second bridge patterns 242 in the second portions B-CA2. In this case, a capacitance between the first bridge patterns 212 and the second bridge patterns 242 may be decreased. Further, the remaining portions of the second bridge pattern 242, which do not overlap the first bridge patterns 212, are provided in the form in which the two or more first lines 242m1 and the two or more second lines 242m2 cross each other, and thus a probability that the second bridge pattern 242 is visually recognized may be decreased due to a difference in external light reflectance.

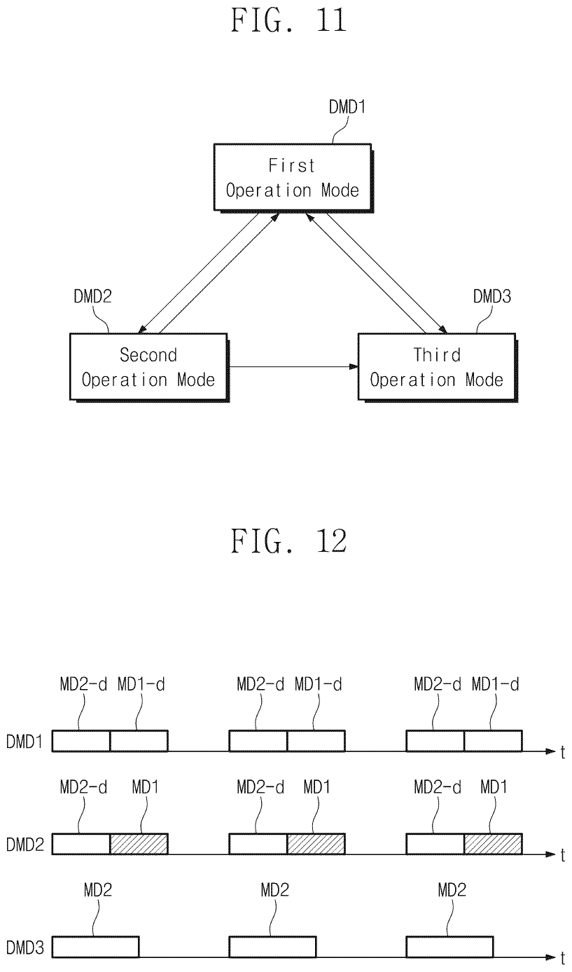

FIG. 11 is a view illustrating an operation of the sensor driver 200C (see FIG. 5) according to one or more embodiments of the present disclosure.

Referring to FIGS. 5 and 11, the sensor driver 200C may be configured to be selectively driven in one of a first operation mode DMD1, a second operation mode DMD2, or a third operation mode DMD3.

The first operation mode DMD1 may be referred to as a touch-and-pen-waiting mode, the second operation mode DMD2 may be referred to as a touch-activation-and-pen-waiting mode, and the third operation mode DMD3 may be referred to as a pen activation mode. The first operation mode DMD1 may be a mode that waits for the first input 2000 and the second input 3000. The second operation mode DMD2 may be a mode that senses the first input 2000, and that waits for the second input 3000. The third operation mode DMD3 may be a mode that senses the second input 3000.

In one or more embodiments of the present disclosure, the sensor driver 200C may be first driven in the first operation mode DMD1. When the first input 2000 is sensed in the first operation mode DMD1, the sensor driver 200C may be switched (or changed) to the second operation mode DMD2. Alternatively, when the second input 3000 is sensed in the first operation mode DMD1, the sensor driver 200C may be switched (or changed) to the third operation mode DMD3.

In one or more embodiments of the present disclosure, when the second input 3000 is sensed in the second operation mode DMD2, the sensor driver 200C may be switched to the third operation mode DMD3. When the first input 2000 is released (or not sensed) in the second operation mode DMD2, the sensor driver 200C may be switched to the first operation mode DMD1. When the second input 3000 is released (or not sensed) in the third operation mode DMD3, the sensor driver 200C may be switched to the first operation mode DMD1.

FIG. 12 is a view illustrating the operation of the sensor driver 200C (see FIG. 5) according to one or more embodiments of the present disclosure.

FIGS. 5, 11, and 12 illustrate operations in the first operation mode DMD1, the second operation mode DMD2, and the third operation mode DMD3 in an order of a time t.

In the first operation mode DMD1, the sensor driver 200C may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scan-driven to detect the first input 2000. FIG. 12 illustrates that the sensor driver 200C is continuously operated in the first mode MD1-d after the second mode MD2-d, but an order thereof is not limited thereto.

In the second operation mode DMD2, the sensor driver 200C may be repeatedly driven in the second mode MD2-d and a first mode MD1. During the second mode MD2-d, the sensor layer 200 may be scan-driven to detect the second input 3000. During the first mode MD1, the sensor layer 200 may be scan-driven to detect coordinates by the first input 2000.

In the third operation mode DMD3, the sensor driver 200C may be driven in a second mode MD2. During the second mode MD2, the sensor layer 200 may be scan-driven to detect coordinates by the second input 3000. In the third operation mode DMD3, the sensor driver 200C may not be operated in the first mode MD1-d or MD1 until the second input 3000 is released (or not sensed).

Referring to FIG. 7 together, in the first mode MD1-d and the first mode MD1, all of the third electrodes 230 and the fourth electrodes 240 may be grounded or a constant voltage may be applied thereto. Alternatively, in the first mode MD1-d and the first mode MD1, all the third electrodes 230 and the fourth electrodes 240 may be floating (or electrically floating). Alternatively, in the first mode MD1-d and the first mode MD1, a signal having the same phase as a transmission signal provided to the first electrodes 210 may be applied to the third electrodes 230 and the fourth electrodes 240. In this case, touch noise may be reduced or prevented from being introduced through the third electrodes 230 and the fourth electrodes 240.

In the second mode MD2-d and the second mode MD2, one end of each of the third electrodes 230 and the fourth electrodes 240 may be floating. Further, in the second mode MD2-d and the second mode MD2, the other end of each of the third electrodes 230 and the fourth electrodes 240 may be grounded or floating. Thus, the compensation for the sensing signal may be improved or maximized by coupling between the first electrodes 210 and the third electrodes 230 and coupling between the second electrodes 220 and the fourth electrodes 240.

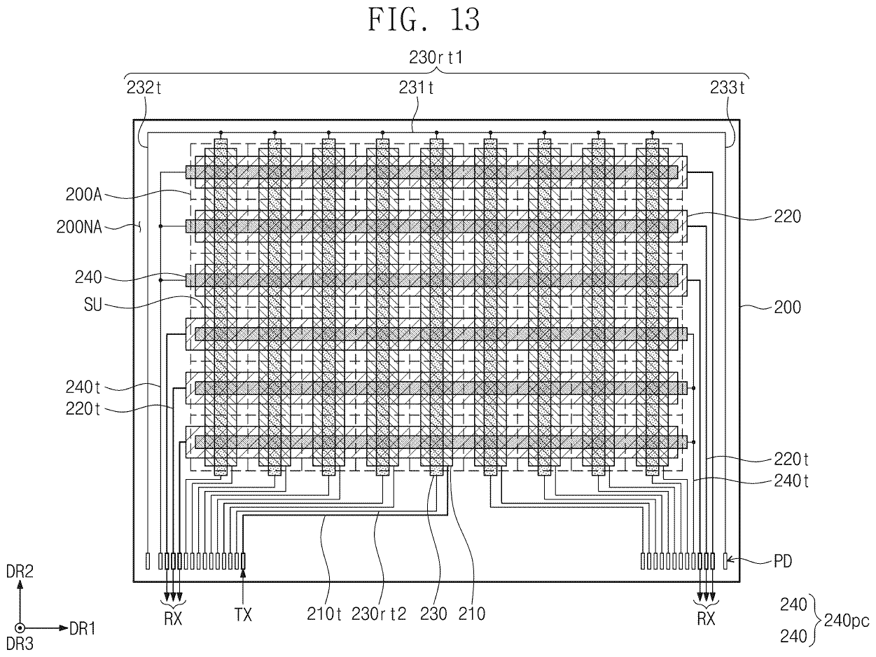

FIG. 13 is a view for describing a first mode according to one or more embodiments of the present disclosure.

Referring to FIGS. 5, 12, and 13, the first mode MD1-d of the first operation mode DMD1, and the first mode MD1 of the second operation mode DMD2, may include a mutual capacitance detecting mode. FIG. 13 is a view for describing the mutual capacitance detecting mode in the first mode MD1-d of the first operation mode DMD1, and the first mode MD1 of the second operation mode DMD2.

In the mutual capacitance detecting mode, the sensor driver 200C may sequentially provide a transmission signal TX to the first electrodes 210, and may detect coordinates for the first input 2000 using a reception signal RX detected through the second electrodes 220. For example, the sensor driver 200C may calculate input coordinates by sensing a change in a mutual capacitance between the first electrodes 210 and the second electrodes 220.

FIG. 13 illustrates that the transmission signal TX is provided to the one first electrode 210, and that the reception signal RX is output from the second electrodes 220. The sensor driver 200C may detect input coordinates for the first input 2000 by sensing the change in the capacitance between the first electrodes 210 and the second electrodes 220.

In one or more embodiments of the present disclosure, at least one of the first mode MD1-d of the first operation mode DMD1 or the first mode MD1 of the second operation mode DMD2 may further include a self-capacitance detecting mode. In the self-capacitance detecting mode, the sensor driver 200C may output driving signals to the first electrodes 210 and the second electrodes 220, and may calculate the input coordinates by sensing the change in the capacitance of each of the first electrodes 210 and the second electrodes 220.

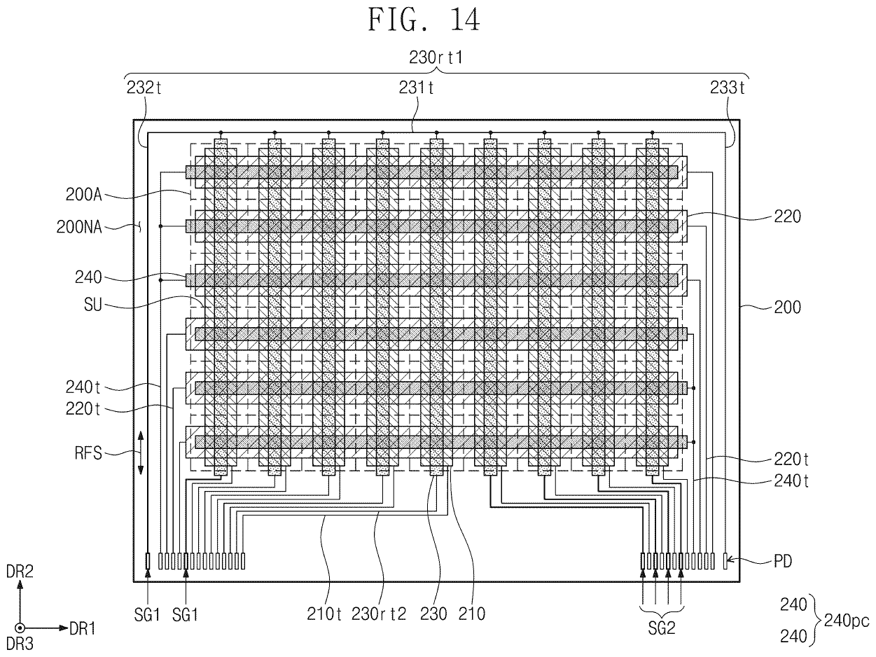

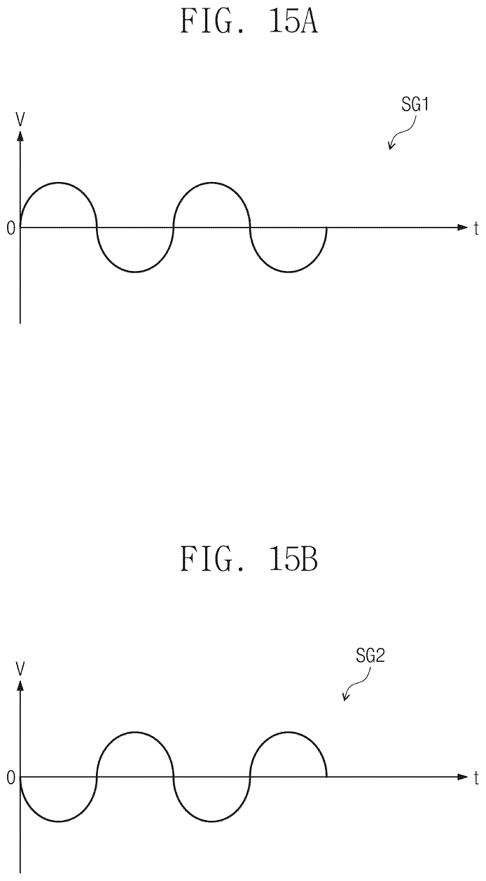

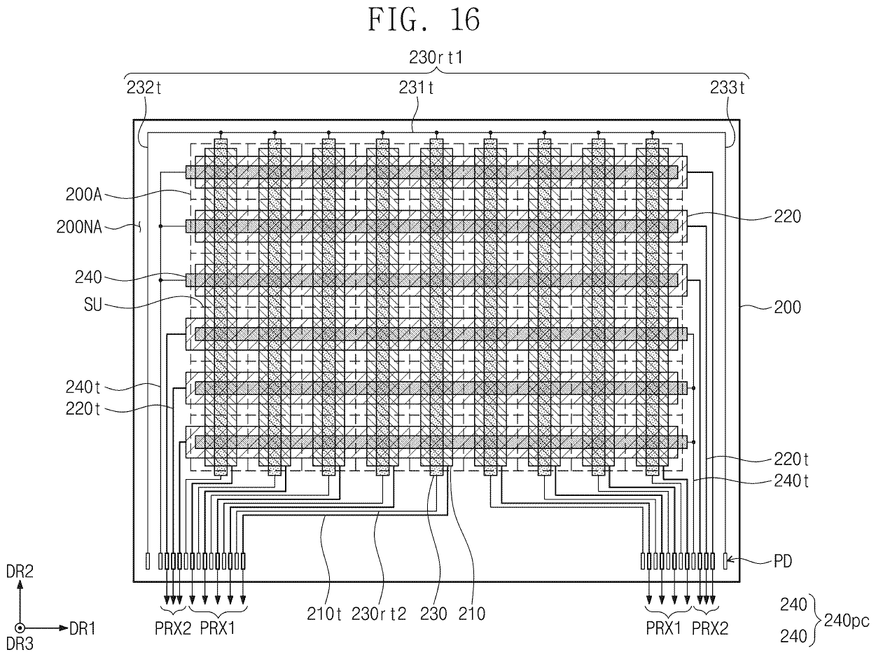

FIG. 14 is a view for describing a second mode, for example, a charging drive mode, according to one or more embodiments of the present disclosure. FIG. 15A is a graph depicting a waveform of a first signal SG1 according to one or more embodiments of the present disclosure. FIG. 15B is a graph depicting a waveform of a second signal SG2 according to one or more embodiments of the present disclosure.

Referring to FIGS. 14, 15A, and 15B, the second mode MD2 may include the charging drive mode. The charging drive mode may include various charging drive modes, and descriptions of the various charging drive modes will be made below.

In the charging drive mode, the sensor driver 200C may apply the first signal SG1 to one of the second line portion 232t, the third line portion 233t, or the fifth trace lines 230rt2, and may apply the second signal SG2 to another one thereof. The second signal SG2 may be an inverse signal of the first signal SG1. For example, the first signal SG1 may be a sinusoidal signal.

According to one or more embodiments of the present disclosure, the first signal SG1 may be provided to at least one first pad among the plurality of pads PD, and the second signal SG2 may be provided to at least one second pad among the plurality of pads PD. The first pad and the second pad may be different pads. At least one pad that is connected to the fifth trace lines 230rt2 between the first pad and the second pad among the pads PD may be referred to as a “gap pad,” and the first signal SG1 and the second signal SG2 may not be provided to the gap pad.

Because the first signal SG1 is provided to the first pad, and the second signal SG2 is applied to the second pad, a current RFS may have a current path in which the current RFS flows to the second pad through the first pad. Further, because the first signal SG1 and the second signal SG2 are sinusoidal signals having an inverse phase relationship, a direction of the current RFS may be changed periodically. In one or more embodiments of the present disclosure, the first signal SG1 and the second signal SG2 may be square wave signals having an inverse phase relationship.

When the first signal SG1 and the second signal SG2 have the inverse phase relationship, noise caused in the display layer 100 (see FIG. 4) by the first signal SG1 may be canceled with noise caused by the second signal SG2. Thus, a flicker phenomenon may not occur in the display layer 100, and display quality of the display layer 100 may be improved.

In one or more embodiments of the present disclosure, the first signal SG1 may be a sinusoidal signal. However, the present disclosure is not limited thereto, and the first signal SG1 may be a square wave signal. Further, the second signal SG2 may have a constant voltage (e.g., predetermined constant voltage). For example, the second signal SG2 may be a ground voltage. That is, the pad to which the second signal SG2 is applied may be considered as being grounded. Even in this case, the current RFS may flow from the one pad to the other one pad. Further, even when the other one pad is grounded, the first signal SG1 is a sinusoidal wave signal or a square wave signal, and thus the direction of the current RFS may be changed periodically.

FIG. 14 illustrates that the first signal SG1 is provided to two first pads, and that the second signal SG2 is provided to four second pads, but the number of first pads to which the first signal SG1 is provided and the number of second pads to which the second signal SG2 is provided are not limited thereto. For example, the number of first pads and the number of second pads may be the same, or may be different from each other.

A current path having a coil shape may be formed by the first signal SG1 provided to the two first pads and the second signal SG2 provided to the four second pads. Thus, in the charging drive mode of the second mode, a resonant circuit of the pen PN may be charged by the current path.

According to the present disclosure, the current path having a loop coil pattern may be implemented by components included in the sensor layer 200. Thus, the electronic device 1000 (see FIG. 1A) may charge the pen PN using the sensor layer 200. Thus, because an additional component having a coil for charging the pen PN is not separately required, an increase in the thickness, an increase in the weight, and a decrease in the flexibility of the electronic device 1000 may not occur.

Further, according to the present disclosure, the second line portion 232t, the third line portion 233t, and the fifth trace lines 230rt2 may be selectively connected by the binder circuits, which will be described below. That is, the third electrodes 230, the second line portion 232t, and the third line portion 233t that constitute the charging loop may be varied. In this case, a charging operation may be subdivided, and accordingly, the position of the charging loop may be finely adjusted, and the resistance of the charging loop may be suitably adjusted. As a result, the charging efficiency and the charging sensitivity of the pen PN (see FIG. 5) charged by the magnetic field provided from the charging loop may be improved. Further, when the charging efficiency and the charging sensitivity of the charged pen PN are improved, the response speed between the pen PN and the sensor layer 200 may be improved.

Further, according to one or more embodiments of the present disclosure, the second line portion 232t and the third line portion 233t may be omitted. In this case, ends of the third electrodes 230 may be connected only by the first line portion 231t. In this case, the fifth trace lines 230rt2 may be selectively connected by the binder circuits, which will be described below.

In the charging drive mode, the first electrodes 210, the second electrodes 220, and the fourth electrodes 240 may be grounded or may be electrically floating, or a constant voltage may be applied thereto. For example, the first electrodes 210, the second electrodes 220, and the fourth electrodes 240 may be floating. In this case, the current RFS may not flow through the first electrodes 210, the second electrodes 220, and the fourth electrodes 240. Further, in the charging drive mode, no signal may be provided to the remaining pads except for the pads to which the first signal SG1 and the second signal SG2 are provided among the pads connected to the fifth trace lines 230rt2, the second line portion 232t, and the third line portion 233t.

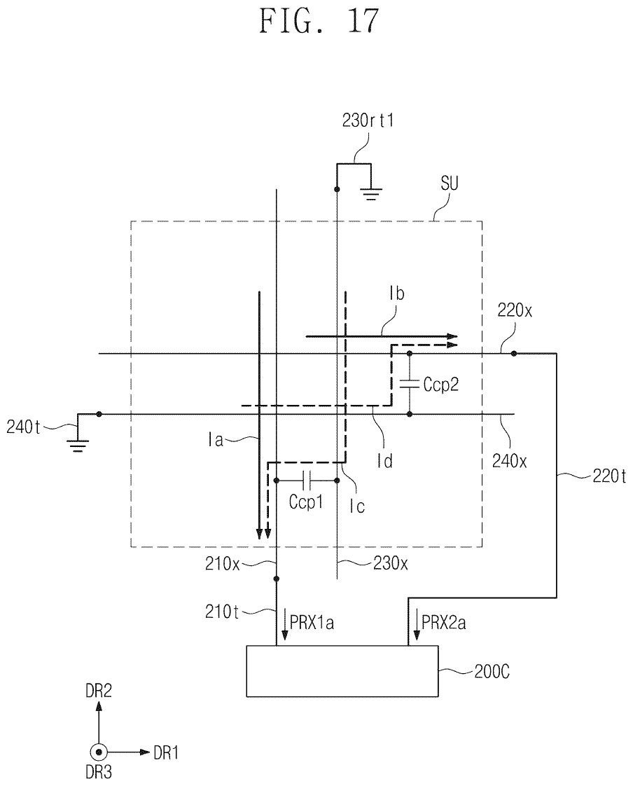

FIG. 16 is a view for describing the second mode, for example, a pen-sensing drive mode, according to one or more embodiments of the present disclosure. FIG. 17 is a view for describing the second mode based on the sensing unit according to one or more embodiments of the present disclosure.

Referring to FIGS. 16 and 17, the second mode may include the charging drive mode and the pen-sensing drive mode. FIGS. 16 and 17 are views for describing the pen-sensing drive mode. Referring to FIG. 16, in the pen-sensing drive mode, first reception signals PRX1 may be output from the first electrodes 210, and second reception signals PRX2 may be output from the second electrodes 220. FIG. 17 illustrates the one sensing unit SU through which a first induced current Ia, a second induced current Ib, a third induced current Ic, and a fourth induced current Id, which are generated by the pen PN, flow.

In one or more embodiments of the present disclosure, routing directions of the one electrode and the other one electrode of the sensor layer 200, which overlap each other, may be different from each other. For example, a routing direction of a first electrode 210x and a routing direction of a third electrode 230x may be different from each other. Further, a routing direction of a second electrode 220x and a routing direction of a fourth electrode 240x may be different from each other. For example, in FIG. 17, the first electrode 210 x and the first trace line 210t may be connected to each other on a lower side of the sensing unit SU, and the third electrode 230x and the third trace line 230rt1 may be connected to each other on an upper side of the sensing unit SU. The second electrode 220 x and the second trace line 220t may be connected to each other on a right side of the sensing unit SU, and the fourth electrode 240x and the fourth trace line 240t may be connected to each other on a left side of the sensing unit SU.

The RLC resonant circuit of the pen PN may emit a magnetic field having a resonant frequency while discharging the charged charges. By the magnetic field provided in the pen PN, the first induced current Ia may be generated in the first electrode 210x, and the second induced current Ib may be generated in the second electrode 220x. Further, the third induced current Ic may be generated in the third electrode 230x, and the fourth induced current Id may be generated in the fourth electrode 240x.

A first coupling capacitor Ccp1 may be formed between the third electrode 230x and the first electrode 210x, and a second coupling capacitor Ccp2 may be formed between the fourth electrode 240x and the second electrode 220x. The third induced current Ic may be transmitted to the first electrode 210x through the first coupling capacitor Ccp1, and the fourth induced current Id may be transmitted to the second electrode 220x through the second coupling capacitor Ccp2.

The sensor driver 200C may receive, from the first electrode 210x, a first reception signal PRX1a based on the first induced current Ia and the third induced current Ic. The sensor driver 200C also may receive, from the second electrode 220x, a second reception signal PRX2a based on the second induced current Ib and the fourth induced current Id. The sensor driver 200C may detect the input coordinates of the pen PN based on the first reception signal PRX1a and the second reception signal PRX2a.

The sensor driver 200C may receive the first reception signal PRX1a from the first electrode 210x, and may receive the second reception signal PRX2a from the second electrode 220x. In this case, one ends of the third electrode 230x and the fourth electrode 240x may be floating. Thus, the compensation for the sensing signal may be improved or maximized by coupling between the first electrode 210x and the third electrode 230x and by coupling between the second electrode 220x and the fourth electrode 240x.

Further, the other ends of the third electrode 230x and the fourth electrode 240x may be grounded or floating. Thus, the third induced current Ic and the fourth induced current Id may be sufficiently transmitted to the first electrode 210x and the second electrode 220x by the coupling between the first electrode 210x and the third electrode 230x and by the coupling between the second electrode 220x and the fourth electrode 240x.

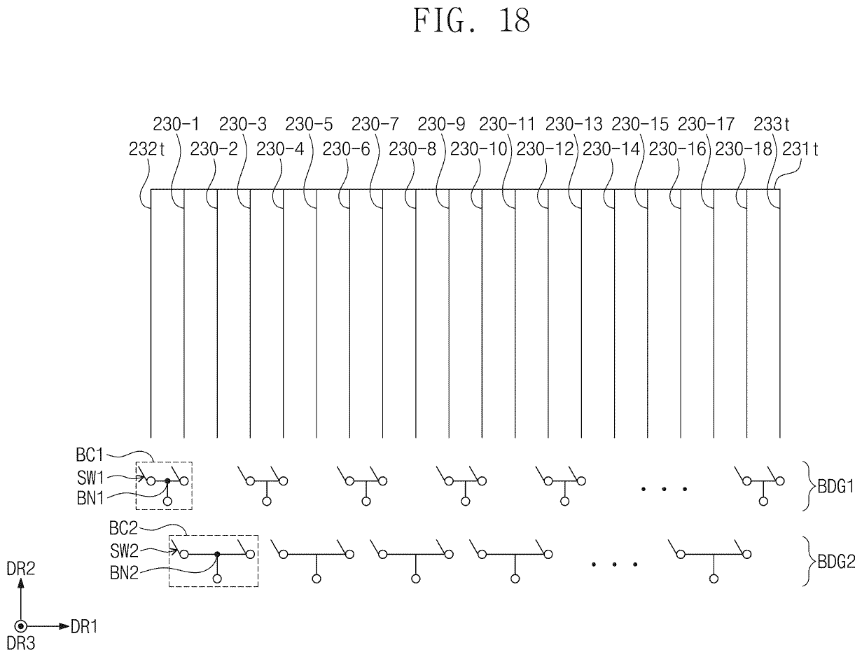

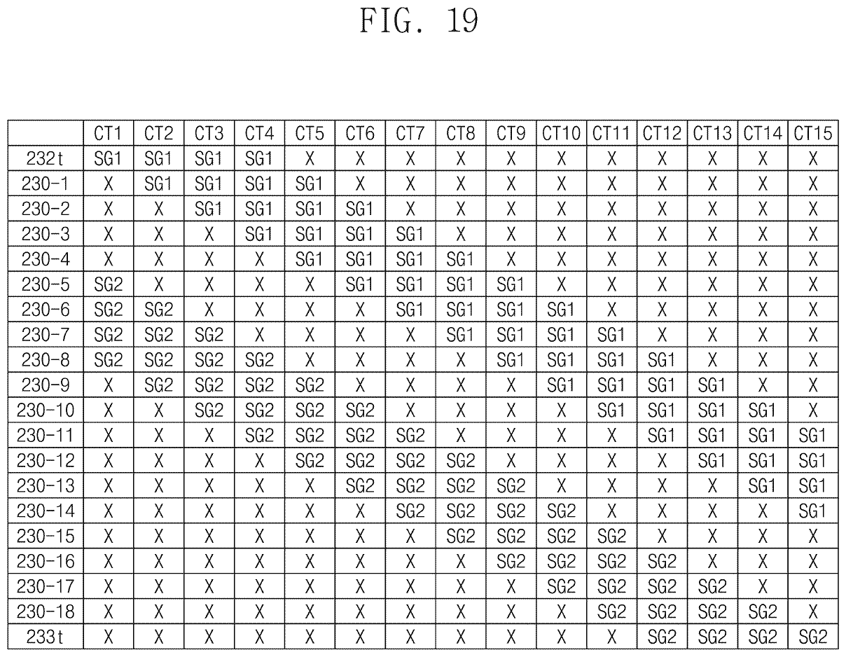

FIG. 18 is a view for describing the second mode, for example, a pen-charging drive mode, according to one or more embodiments of the present disclosure.

Referring to FIGS. 14, 18 third electrodes 230-1, 230-2, 230-3, 230-4, 230-5, 230-6, 230-7, 230-8, 230-9, 230-10, 230-11, 230-12, 230-13, 230-14, 230-15, 230-16, 230-17, and 230-18, (hereinafter, referred to as 230-1 to 230-18), the first line portion 231t, the second line portion 232t, and the third line portion 233t are briefly illustrated in a line shape.

The third electrodes 230-1 to 230-18, the second line portion 232t, and the third line portion 233t may correspond to components forming the charging loop, and thus may be referred to as charging electrodes. Depending on a product size, a product design specification, or the like, the number of third electrodes 230-1 to 230-18 may be greater than 18 or less than 18, and the second line portion 232t and the third line portion 233t may be omitted.

The electronic device 1000 (see FIG. 1A) may further include a primary binder group BDG1 and a secondary binder group BDG2. Each of the primary binder group BDG1 and the secondary binder group BDG2 may be provided to be selectively connected to some of the third electrodes 230-1 to 230-18, the second line portion 232t, and/or the third line portion 233t and to form the charging loop.

Each of the primary binder group BDG1 and the secondary binder group BDG2 may be implemented as the integrated circuit IC together with the sensor driver 200C (see FIG. 5), and may be included in a single chip. However, the present disclosure is not for example limited thereto. For example, at least one of the primary binder group BDG1 or the secondary binder group BDG2 may be included in the display panel DP (see FIG. 4). Alternatively, the electronic device 1000 (see FIG. 1A) may further include a printed circuit board electrically connected to the display panel DP, and at least one of the primary binder group BDG1 or the secondary binder group BDG2 may be included in the printed circuit board. When the primary binder group BDG1 and the secondary binder group BDG2 are included in the display panel DP or the printed circuit board, a size and manufacturing costs of the single chip may be decreased as compared to a case in which the primary binder group BDG1 and the secondary binder group BDG2 are included in the single chip.

Further, FIG. 18 illustrates that the electronic device 1000 includes the primary binder group BDG1 and the secondary binder group BDG2, but the electronic device 1000 may further include a tertiary binder group. In this case, the first signal SG1 or the second signal SG2 may be provided to up to eight channels among the third electrodes 230-1 to 230-18, the second line portion 232t, and the third line portion 233t.

The primary binder group BDG1 may include a plurality of primary binder circuits BC1, and the secondary binder group BDG2 may include a plurality of secondary binder circuits BC2. The primary binder circuits BC1 may be controlled to be selectively connected to at least some of the third electrodes 230-1 to 230-18, the second line portion 232t, and/or the third line portion 233t. The secondary binder circuits BC2 may be controlled to be selectively connected to at least some of the primary binder circuits BC1.

Each of the primary binder circuits BC1 may include a plurality of first switches SW1 connected to a first node BN1. Each of the secondary binder circuits BC2 may include a plurality of second switches SW2 connected to a second node BN2. Each of the first switches SW1 and the second switches SW2 may include a transistor, but the present disclosure is not limited thereto.

FIG. 19 is a table representing signals provided to the sensor layer according to one or more embodiments of the present disclosure. In detail, FIG. 19 is a table representing signals provided to the second line portion 232t, the third electrodes 230-1 to 230-18, and the third line portion 233t.

Referring to FIGS. 18 and 19, in the charging drive mode, the sensor driver 200C (see FIG. 15) may output the first signal SG1 to at least one secondary binder circuit (hereinafter, referred to as a first transfer circuit) among the secondary binder circuits BC2, may output the second signal SG2 to at least one other one secondary binder circuit (hereinafter, referred to as a second transfer circuit) among the secondary binder circuits BC2, and thus may provide the charging loop.

The first signal SG1 may be transmitted to Y first intermediate transfer circuits (Y being an integer that is greater than or equal to one) electrically connected to the first transfer circuit among the primary binder circuits BC1, and the second signal SG2 may be transmitted to Z second intermediate transfer circuits (Z being an integer that is greater than or equal to one) electrically connected to the second transfer circuit among the primary binder circuits BC1. The Y and the Z may be variable values.

The first signal SG1 may be transmitted to W third electrodes (hereinafter, referred to as a first loop electrode, W being an integer that is greater than or equal to one) electrically connected to the first transfer circuit among the third electrodes 230-1 to 230-18, the second line portion 232t, and the third line portion 233t. The second signal SG2 may be transmitted to X third electrodes (hereinafter, referred to as a second loop electrode, X being an integer that is greater than or equal to zero) electrically connected to the Z second intermediate transfer circuits among the third electrodes 230-1 to 230-18, the second line portion 232t, and the third line portion 233t. The W and the X may be variable values.

FIG. 19 illustrates 15 charging cases CT1, CT2, CT3, CT4, CT5, CT6, CT7, CT8, CT9, CT10, CT11, CT12, CT13, CT14, and CT15 (hereinafter referred to as CT1 to CT15) according to one or more embodiments of the present disclosure.

Each of the second line portion 232t, the third electrodes 230-1 to 230-18, and the third line portion 233t may correspond to one channel. It is illustrated that the 15 charging cases CT1 to CT15 are provided by moving the first signal SG1 and the second signal SG2 by one channel, but the present disclosure is not for example limited thereto. Further, it is illustrated that the number of gap electrodes between a channel to which the first signal SG1 is provided, and a channel to which the second signal SG2 is provided in the 15 charging cases CT1 to CT15 is four, but the present disclosure is not for example limited thereto. For example, the number of gap electrodes may be less than or greater than four, and the number of gap electrodes might not be fixed and may vary.

According to one or more embodiments of the present disclosure, the number of charging electrodes to which the first signal SG1 or the second signal SG2 is provided may be freely selected from one to four by the primary binder circuits BC1 and the secondary binder circuits BC2. Thus, the number of charging cases CT1 to CT15 utilizing the third electrodes 230-1 to 230-18, the second line portion 232t, and the third line portion 233t may be increased (e.g., to the maximum). As the number of available charging cases CT1 to CT15 is increased, a position in which a magnetic field is formed may be precisely adjusted. Thus, the charging efficiency and the charging sensitivity of the pen PN (see FIG. 5), which may be charged by the magnetic field provided from the charging loop, may be improved. Accordingly, a response speed between the pen PN and the sensor layer 200 may be improved.

Referring to FIGS. 7, 18, and 19 together, in the first charging case CT1, the first signal SG1 may be provided to the second line portion 232t, and the second signal SG2 may be provided to the fifth to eighth third electrodes 230-5, 230-6, 230-7, and 230-8. The third electrodes 230 may include U gap electrodes (U being an integer that is greater than or equal to one) between the second line portion 232t and the fifth to eighth third electrodes 230-5, 230-6, 230-7, and 230-8, and FIG. 19 illustrates that the first to fourth third electrodes 230-1, 230-2, 230-3, and 230-4 are the gap electrodes.

In the one charging case, the W first loop electrodes, the U gap electrodes, and the X second loop electrodes may be continuously and sequentially arranged in the first direction DR1. For example, in the first charging case CT1, the second line portion 232t may correspond to the W first loop electrodes, the first to fourth third electrodes 230-1, 230-2, 230-3, and 230-4 may correspond to the U gap electrodes, and the fifth to eighth third electrodes 230-5, 230-6, 230-7, and 230-8 may correspond to the X second loop electrodes.

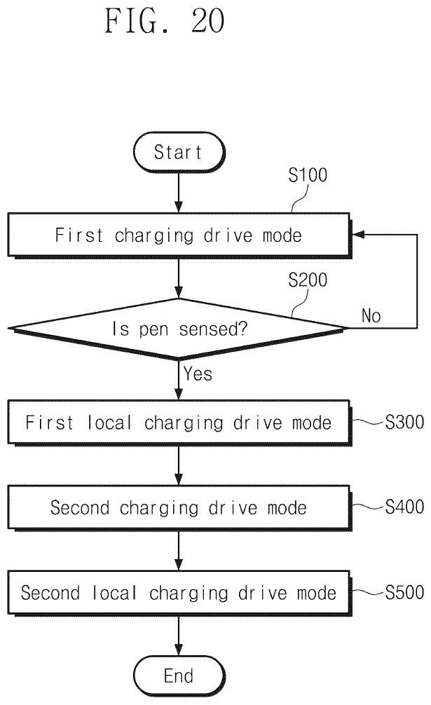

FIG. 20 is a flowchart illustrating a method of driving the sensor layer 200 (see FIG. 5) according to one or more embodiments of the present disclosure.

Referring to FIGS. 5, 18, and 20, the second mode MD2-d or MD2 (see FIG. 12) may include the charging drive mode.

The sensor driver 200C may be operated in a first charging drive mode (S100). The first charging drive mode may be a searching charging drive mode (or referred to as a scan charging drive mode or a global charging drive mode) for sensing the presence of the pen PN. Thus, the entire area of the sensor layer 200 may be quickly scanned.

In the second mode MD2-d or MD2, the sensor driver 200C may be alternately and repeatedly operated in one time interval of the first charging drive mode and the pen-sensing drive mode described with reference to FIGS. 16 and 17.

The sensor driver 200C may determine whether the pen PN is sensed (S200). When the pen PN is not sensed, the sensor driver 200C may be operated in a next time interval of the first charging drive mode. When the pen PN is sensed, an operation of the sensor driver 200C may be switched to a first local charging drive mode (S300).

The sensor driver 200C may be operated in the first local charging drive mode, and then may be switched to a second charging drive mode (S400). Thereafter, the sensor driver 200C may be operated in the second charging drive mode, and then may be switched to a second local charging drive mode (S500).

After the pen PN is sensed, the operation of the sensor driver 200C may be sequentially switched to the first local charging drive mode, the second charging drive mode, and the second local charging drive mode. This may be a process for improving the charging efficiency and the charging sensitivity of the pen PN (see FIG. 5) by finely adjusting the position of the charging loop.

Hereinafter, the first charging drive mode, the first local charging drive mode, the second charging drive mode, and the second local charging drive mode will be described in detail.

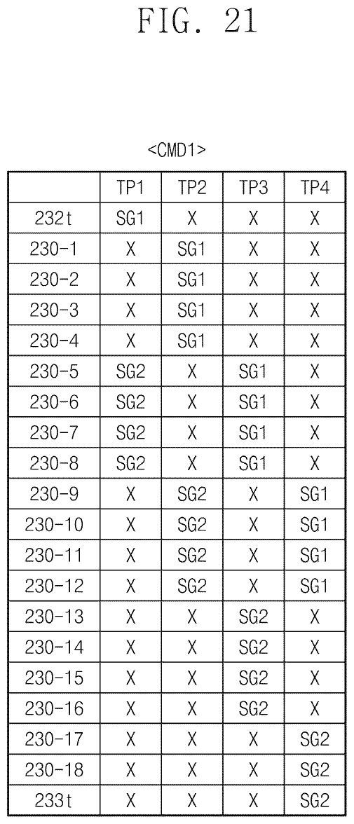

FIG. 21 is a table representing signals provided to the sensor layer 200 (see FIG. 5) in a first charging drive mode CMD1 according to one or more embodiments of the present disclosure.

Referring to FIGS. 5, 18, and 21, in the first charging drive mode CMD1, the sensor driver 200C may be driven to quickly scan the entire area of the sensor layer 200.

FIG. 21 illustrates an example in which the first signal SG1 and the second signal SG2 are provided to the third electrodes 230-1 to 230-18, the second line portion 232t, and the third line portion 233t, in each of first to fourth time intervals TP1, TP2, TP3, and TP4 of the first charging drive mode CMD1.

In the first time interval TP1, the first signal SG1 may be provided to the second line portion 232t, and the second signal SG2 may be provided to the fifth to eighth third electrodes 230-5, 230-6, 230-7, and 230-8. Thus, a first charging loop in the first time interval TP1 may include the second line portion 232t and the fifth to eighth third electrodes 230-5, 230-6, 230-7, and 230-8.

In the second time interval TP2 that is temporally continuous with the first time interval TP1, the first signal SG1 may be provided to the first to fourth third electrodes 230-1, 230-2, 230-3, and 230-4, and the second signal SG2 may be provided to the ninth to twelfth third electrodes 230-9, 230-10, 230-11, and 230-12. Thus, a second charging loop in the second time interval TP2 may include the first to fourth third electrodes 230-1, 230-2, 230-3, and 230-4 and the ninth to twelfth third electrodes 230-9, 230-10, 230-11, and 230-12.

The second line portion 232t in the first time interval TP1 may be referred to as the W first loop electrode(s) in the first time interval TP1, and the fifth to eighth third electrodes 230-5, 230-6, 230-7, and 230-8 in the first time interval TP1 may be referred to as the X second loop electrodes in the first time interval TP1. Further, the first to fourth third electrodes 230-1, 230-2, 230-3, and 230-4 in the second time interval TP2 may be referred to as the W first loop electrodes in the second time interval TP2, and the ninth to twelfth third electrodes 230-9, 230-10, 230-11, and 230-12 in the second time interval TP2 may be referred to as the X second loop electrodes in the second time interval TP2.

In the first charging drive mode CMD1, the W first loop electrodes 232t in the first time interval TP1 and the W first loop electrodes 230-1, 230-2, 230-3, and 230-4 in the second time interval TP2 may not overlap each other (e.g., there might be no common ones of the W first loop electrodes in both the first time interval TP1 and the second time interval TP2). Further, in the first charging drive mode CMD1, the X second loop electrodes 230-5, 230-6, 230-7, and 230-8 in the first time interval TP1 and the X second loop electrodes 230-9, 230-10, 230-11, and 230-12 in the second time interval TP2 may not overlap each other.

According to one or more embodiments of the present disclosure, in the first charging drive mode CMD1, the first time interval TP1 may correspond to the first charging case CT1 of FIG. 18, the second time interval TP2 may correspond to the fifth charging case CT5 of FIG. 18, the third time interval TP3 may correspond to the ninth charging case CT9 of FIG. 18, and the fourth time interval TP4 may correspond to the thirteenth charging case CT13 of FIG. 18. However, this is merely an example, and the present disclosure is not for example limited thereto. For example, in the first charging drive mode CMD1, the first time interval TP1 may correspond to the second charging case CT2 of FIG. 18, the second time interval TP2 may correspond to the sixth charging case CT6 of FIG. 18, the third time interval TP3 may correspond to the tenth charging case CT10 of FIG. 18, and the fourth time interval TP4 may correspond to the fourteenth charging case CT14 of FIG. 18.

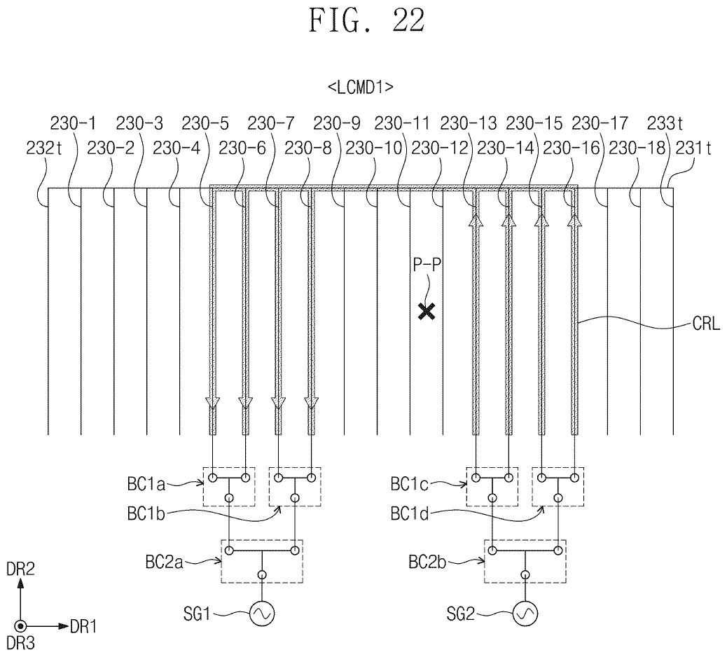

FIG. 22 is a view for describing a first local charging drive mode LCMD1 according to one or more embodiments of the present disclosure.

Referring to FIGS. 5 and 22, when the pen PN is sensed, the sensor driver 200C may be switched from the first charging drive mode CMD1 (see FIG. 21) to the first local charging drive mode LCMD1 to be operated. FIG. 22 illustrates a position P-P of the sensed pen PN.

In the first local charging drive mode LCMD1, the W first loop electrodes and the X second loop electrodes may be selected so that a charging loop CRL overlaps an area in which an input of the pen PN is sensed. That is, the sensor driver 200C may be driven to form one of the charging loops CRL in the first charging drive mode CMD1, which may be referred to as the first local charging drive mode LCMD1.

The charging loop CRL illustrated in FIG. 22 may correspond to a charging loop of the third time interval TP3 of FIG. 21. In FIG. 22, the W first loop electrodes may be the fifth to eighth third electrodes 230-5, 230-6, 230-7, and 230-8, and the X second loop electrodes may be thirteenth to sixteenth third electrodes 230-13, 230-14, 230-15, and 230-16.

Referring to FIGS. 18 and 22, the primary binder circuits BC1 may include first intermediate transfer circuits BC1a and BC1b and second intermediate transfer circuits BC1c and BC1d electrically connected to loop electrodes constituting the charging loop CRL. The secondary binder circuits BC2 may include a first transfer circuit BC2a and a second transfer circuit BC2b electrically connected to loop electrodes constituting the charging loop CRL. FIG. 22 illustrates the first intermediate transfer circuits BC1a and BC1b, the second intermediate transfer circuits BC1c and BC1d, the first transfer circuit BC2a, and the second transfer circuit BC2b electrically connected to the charging loop CRL in the primary binder circuits BC1 and the secondary binder circuits BC2.

The first signal SG1 may be transmitted to the fifth to eighth third electrodes 230-5, 230-6, 230-7, and 230-8 through the first transfer circuit BC2a and the first intermediate transfer circuits BC1a and BC1b. The second signal SG2 may be transmitted to the thirteenth to sixteenth third electrodes 230-13, 230-14, 230-15, and 230-16 through the second transfer circuit BC2b and the second intermediate transfer circuits BC1c and BC1d. Thus, the charging loop CRL may include the first transfer circuit BC2a, the first intermediate transfer circuits BC1a and BC1b, the fifth to eighth third electrodes 230-5, 230-6, 230-7, and 230-8, the second transfer circuit BC2b, the second intermediate transfer circuits BC1c and BC1d, and the thirteenth to sixteenth third electrodes 230-13, 230-14, 230-15, and 230-16.

According to one or more embodiments of the present disclosure, channels to which the first signal SG1 is provided are arranged spatially continuous with each other and adjacent to each other. Further, channels to which the second signal SG2 is provided are arranged spatially continuous with each other and adjacent to each other. Thus, as each of the first signal SG1 and the second signal SG2 is provided to the four channels, a magnetic field density provided to an upper portion of the sensor layer 200 (see FIG. 7) may be strengthened by improving or maximizing spatial integration even when the current is distributed to the four channels.

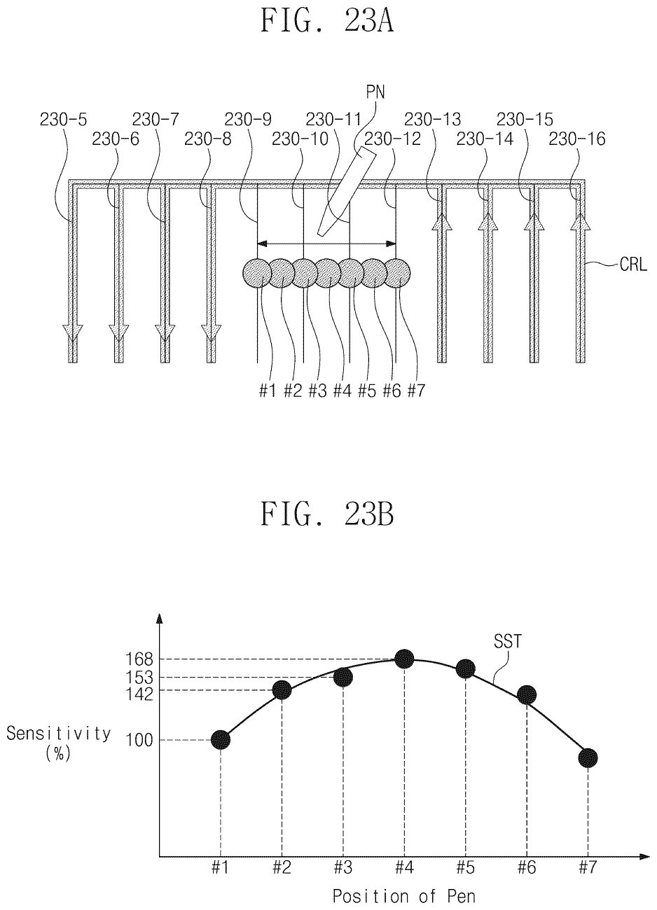

FIG. 23A is a view illustrating one charging loop CRL and pen positions #1, #2, #3, #4, #5, #6, and #7 according to one or more embodiments of the present disclosure. FIG. 23B is a graph depicting charging sensitivity according to the charging loop and the pen position illustrated in FIG. 23A.

Referring to FIG. 23A, the one charging loop CRL and the seven positions #1, #2, #3, #4, #5, #6, and #7 of the pen PN overlapping the one charging loop CRL are illustrated.

Referring to FIGS. 23A and 23B, when the charging sensitivity of the pen PN at the first position #1 is set as 100%, relative values of the charging sensitivities according to the positions #1, #2, #3, #4, #5, #6, and #7 of the pen PN are illustrated. Referring to a schematic trajectory SST obtained by connecting changes in the charging sensitivities, it may be identified that, as the position of the pen PN becomes closer to the charging loop CRL, the charging sensitivities are gradually increased, and as the position of the pen PN becomes farther from a center thereof, the charging sensitivities are gradually decreased.

That is, it may be identified that, even when the position of the pen PN overlaps the charging loop CRL, a difference between the charging sensitivities of a position in which the charging sensitivity is lowest and a position in which the charging sensitivity is highest is 68% or more. According to the present disclosure, a connection relationship between the primary binder circuits BC1 (see FIG. 18) and the secondary binder circuits BC2 (see FIG. 18) is controlled so that the position of the charging loop CRL may be more precisely changed. Thus, the charging efficiency and the charging sensitivity of the pen PN charged by the magnetic field provided from the charging loop of which the position is more precisely adjusted may be improved. Accordingly, the response speed between the pen PN and the sensor layer 200 may be improved.

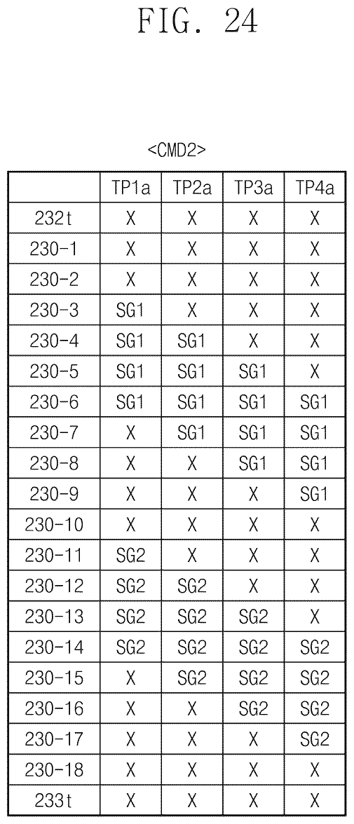

FIG. 24 is a table representing signals provided to the sensor layer in a second charging drive mode CMD2 according to one or more embodiments of the present disclosure.

Referring to FIG. 24, in the second charging drive mode CMD2, which is different from the first charging drive mode CMD1, the sensor driver 200C may be driven so that a partial area of the sensor layer 200 is scanned.

When the first charging drive mode CMD1 is a mode of quickly scanning the entire area of the sensor layer 200 to sense the presence of the pen PN, the second charging drive mode CMD2 may be a mode of scanning to find the position of the charging loop for providing the improved (e.g., the maximum) charging sensitivity sensing after the position of the pen PN is sensed. Thus, the second charging drive mode CMD2 may be referred to as a fine scan charging drive mode or a local scan charging drive mode.

FIG. 24 illustrates an example in which the first signal SG1 and the second signal SG2 are provided to the third electrodes 230-1 to 230-18, the second line portion 232t, and the third line portion 233t in each of first to fourth time intervals TP1 a, TP2a, TP3a, and TP4a of the second charging drive mode CMD2.

A plurality of fine charging loops may be formed in the first to fourth time intervals TP1a, TP2a, TP3a, and TP4a. The fine charging loop formed on one of the first to fourth time intervals TP1a, TP2a, TP3a, or TP4a may correspond to the one charging loop CRL illustrated in FIG. 23A.

In the first time interval TP1a, the first signal SG1 may be provided to the third to sixth third electrodes 230-3, 230-4, 230-5, and 230-6, and the second signal SG2 may be provided to the eleventh to fourteenth third electrodes 230-11, 230-12, 230-13, and 230-14. Thus, a first fine charging loop in the first time interval TP1a may include the third to sixth third electrodes 230-3, 230-4, 230-5, and 230-6 and the eleventh to fourteenth third electrodes 230-11, 230-12, 230-13, and 230-14.

In the second time interval TP2a that is temporally continuous with the first time interval TP1a, the first signal SG1 may be provided to the fourth to seventh third electrodes 230-4, 230-5, 230-6, and 230-7, and the second signal SG2 may be provided to the twelfth to fifteenth third electrodes 230-12, 230-13, 230-14, and 230-15. Thus, a second fine charging loop in the second time interval TP2a may include the fourth to seventh third electrodes 230-4, 230-5, 230-6, and 230-7 and the twelfth to fifteenth third electrodes 230-12, 230-13, 230-14, and 230-15.

The third to sixth third electrodes 230-3, 230-4, 230-5, and 230-6 in the first time interval TP1a may be referred to as the W first loop electrodes in the first time interval TP1a, and the eleventh to fourteenth third electrodes 230-11, 230-12, 230-13, and 230-14 in the first time interval TP1a may be referred to as the X second loop electrodes in the first time interval TP1a. Further, the fourth to seventh third electrodes 230-4, 230-5, 230-6, and 230-7 in the second time interval TP2a may be referred to as the W first loop electrodes in the second time interval TP2a, and the twelfth to fifteenth third electrodes 230-12, 230-13, 230-14, and 230-15 in the second time interval TP2a may be referred to as the X second loop electrodes in the second time interval TP2a.

In the second charging drive mode CMD2, the W first loop electrodes 230-3, 230-4, 230-5, and 230-6 in the first time interval TP1a, and the W first loop electrodes 230-4, 230-5, 230-6, and 230-7 in the second time interval TP2a, may overlap each other (e.g., one or more of the W first loop electrodes in the first time interval TP1a and the second time interval TP2a may be the same). Further, in the second charging drive mode CMD2, the X second loop electrodes 230-11, 230-12, 230-13, and 230-14 in the first time interval TP1a and the X second loop electrodes 230-12, 230-13, 230-14, and 230-15 in the second time interval TP2a may overlap each other.

According to one or more embodiments of the present disclosure, it is illustrated that, in the second charging drive mode CMD2, four fine charging loops are sequentially formed along the first to fourth time intervals TP1a, TP2a, TP3a, and TP4a, but the present disclosure is not for example limited thereto. For example, two or more fine charging loops may be formed sequentially.

The first to fourth time intervals TP1a, TP2a, TP3a, and TP4a may correspond to four continuous charging cases illustrated in FIG. 18. For example, FIG. 24 illustrates that the first to fourth time intervals TP1a, TP2a, TP3a, and TP4a correspond to the seventh charging case CT4 to the tenth charging case CT10, but the first to fourth time intervals TP1a, TP2a, TP3a, and TP4a may be variously changed depending on the sensed position of the pen PN.

Hereinafter, the first charging drive mode CMD1 described in FIG. 21 and the second charging drive mode CMD2 of FIG. 24 will be compared and described.

Referring to FIG. 21, in the first charging drive mode CMD1, a plurality of charging loops generated in the first to fourth time intervals TP1, TP2, TP3, and TP4 may be moved and sequentially formed in the first direction DR1. In this case, a pitch between the first charging loop in the first time interval TP1 and the second charging loop in the second time interval TP2 may correspond to the four channels. For example, a distance between the eighth third electrode 230-8 that is the last channel of the first charging loop to which the second signal SG2 is provided, and the twelfth third electrode 230-12 that is the last channel of the second charging loop to which the second signal SG2 is provided, may correspond to a pitch between adjacent charging loops.

Referring to FIG. 24, in the second charging drive mode CMD2, a plurality of charging loops generated in the first to fourth time intervals TP1a, TP2a, TP3a, and TP4a may be moved and sequentially formed in the first direction DR1. In this case, a pitch between a first charging loop in the first time interval TP1a and a second charging loop in the second time interval TP2a may correspond to the one channel. For example, a distance between the fourteenth third electrode 230-14 that is the last channel of the first charging loop to which the second signal SG2 is provided, and the fifteenth third electrode 230-15 that is the last channel of the second charging loop to which the second signal SG2 is provided, may correspond to the pitch between adjacent charging loops. Thus, the pitch between the plurality of charging loops in the first charging drive mode CMD1 may be greater than the pitch between the plurality of charging loops in the second charging drive mode CMD2.

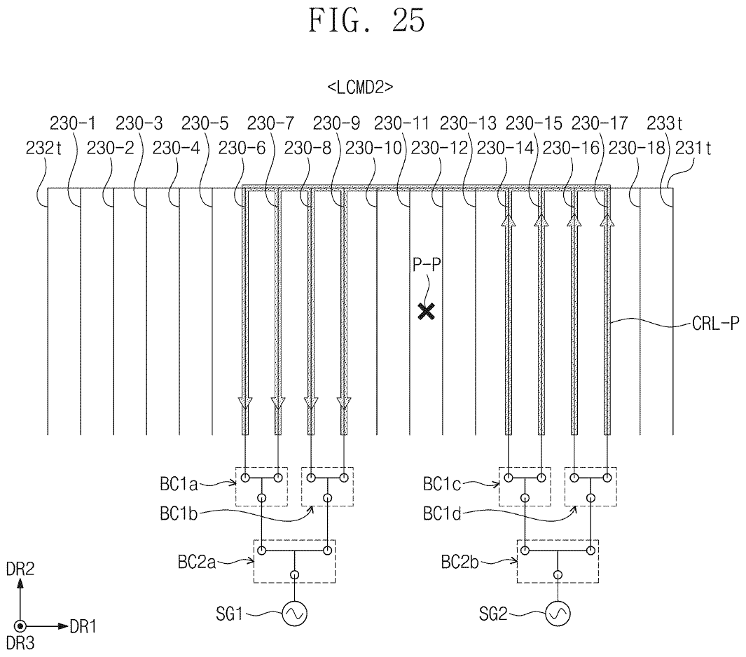

FIG. 25 is a view for describing a second local charging drive mode LCMD2 according to one or more embodiments of the present disclosure.

Referring to FIGS. 5, 24, and 25, the sensor driver 200C may be operated in the second charging drive mode CMD2 and then switched to the second local charging drive mode LCMD2 and operated. FIG. 25 illustrates a position P-P of the sensed pen PN together. In the second local charging drive mode LCMD2, the sensor driver 200C may be driven to form one charging loop CRL-P among the fine charging loops in the second charging drive mode CMD2 (see FIG. 24).

Referring to FIG. 25, the position P-P of the pen PN may be positioned to be close to or adjacent to a center of the charging loop CRL-P. The charging loop CRL-P illustrated in FIG. 25 may correspond to the fine charging loop in the fourth time interval TP4a of the second charging drive mode CMD2.

At least some of the primary binder circuits BC1a, BC1b, BC1c, and/or BC1d may be controlled to be selectively connected to at least some of the third electrodes 230-1 to 230-18, the second line portion 232t, and/or the third line portion 233t. Further, at least some of the secondary binder circuits BC2a and/or BC2b may be controlled to be selectively connected to at least some of the primary binder circuits BC1a, BC1b, BC1c, and/or BC1d.

The sensor driver 200C may output the first signal SG1 to the first transfer circuit BC2a, and may output the second signal SG2 to the second transfer circuit BC2b. The primary binder circuits BC1a, BC1b, BC1c, and BC1d may include the first intermediate transfer circuits BC1a and BC1b connected to the first transfer circuit BC2a, and the second intermediate transfer circuits BC1c and BC1d connected to the second transfer circuit BC2b.

The first signal SG1 may be transmitted to the sixth to ninth third electrodes 230-6, 230-7, 230-8, and 230-9 through the first transfer circuit BC2a and the first intermediate transfer circuits BC1a and BC1b. The second signal SG2 may be transmitted to the fourteenth to seventeenth third electrodes 230-14, 230-15, 230-16, and 230-17 through the second transfer circuit BC2b and the second intermediate transfer circuits BC1c and BC1d. Thus, the charging loop CRL-P may include the first transfer circuit BC2a, the first intermediate transfer circuits BC1a and BC1b, the sixth to ninth third electrodes 230-6, 230-7, 230-8, and 230-9, the second transfer circuit BC2b, the second intermediate transfer circuits BC1c and BC1d, and the fourteenth to seventeenth third electrodes 230-14, 230-15, 230-16, and 230-17.

According to one or more embodiments of the present disclosure, the position P-P of the pen PN may be positioned in a center of the charging loop CRL-P in the first direction DR1 or at an area adjacent to the center. That is, the charging electrodes that form the charging loop are formed using the primary binder circuits BC1a, BC1b, BC1c, and BC1d and the secondary binder circuits BC2a and BC2b, and thus the position of the charging loop may be finely adjusted, and the resistance of the charging loop may be suitably adjusted. As a result, the charging efficiency and the charging sensitivity of the pen PN (see FIG. 5) charged by the magnetic field provided from the charging loop may be improved. Accordingly, the response speed between the pen PN and the sensor layer 200 may be improved.

According to the above description, an electronic device may include a plurality of charging electrodes and binder circuits selectively and electrically connected to the plurality of charging electrodes. Various charging loops may be provided by the binder circuits connected to the plurality of charging electrodes in various combinations. Thus, a position of the charging loop may be finely adjusted, and resistance of the charging loop may be suitably adjusted. In this case, charging efficiency and charging sensitivity of a pen may be improved. Further, as the charging efficiency and the charging sensitivity of the pen are improved, a response speed may be improved.

Although the description has been made above with reference to one or more embodiments of the present disclosure, it may be understood that those skilled in the art or those having ordinary knowledge in the art may variously modify and change the present disclosure without departing from the spirit and technical scope of the present disclosure described in the appended claims. Thus, the technical scope of the present disclosure is not limited to the detailed description of the specification but should be defined by the appended claims, with functional equivalents thereof to be included therein.

What is claimed is:

1. An electronic device comprising:
charging electrodes arranged in a first direction;
primary binder circuits configured to be selectively connected to one or more of the charging electrodes, and comprising first switches connected to a first node; and
secondary binder circuits configured to be selectively connected to one or more of the primary binder circuits, and comprising second switches connected to a second node.

2. The electronic device of claim 1, wherein the secondary binder circuits comprise a first transfer circuit configured to receive a first signal, and a second transfer circuit configured to receive a second signal that is different from the first signal.

3. The electronic device of claim 2, wherein the charging electrodes comprise W first loop electrodes electrically connected to the first transfer circuit, W being an integer that is greater than or equal to one, and X second loop electrodes electrically connected to the second transfer circuit, X being an integer that is greater than or equal to one, and
wherein W and X are variable values.

4. The electronic device of claim 2, wherein the primary binder circuits comprise Y first intermediate transfer circuits electrically connected to the first transfer circuit, Y being an integer that is greater than or equal to one, and Z second intermediate transfer circuits electrically connected to the second transfer circuit, Z being an integer that is greater than or equal to one, and
wherein Y and Z are variable values.

5. The electronic device of claim 4, wherein the charging electrodes comprise W first loop electrodes electrically connected to the Y first intermediate transfer circuits, W being an integer that is greater than or equal to one, and X second loop electrodes electrically connected to the Z second intermediate transfer circuits, X being an integer that is greater than or equal to one, and
wherein W and X are variable values.

6. The electronic device of claim 5, wherein there is defined a charging loop comprising the first transfer circuit, the Y first intermediate transfer circuits, the W first loop electrodes, the second transfer circuit, the Z second intermediate transfer circuits, and the X second loop electrodes.

7. The electronic device of claim 6, further comprising a sensor driver configured to output the first signal and the second signal,
wherein, when the sensor driver is operated in a first charging drive mode, the charging loop comprises a first charging loop in a first time interval in the first charging drive mode, and a second charging loop in a second time interval that is temporally continuous with the first time interval,
wherein the W first loop electrodes in the first charging loop and the W first loop electrodes in the second charging loop do not overlap each other, and
wherein the X second loop electrodes in the first charging loop and the X second loop electrodes in the second charging loop do not overlap each other.

8. The electronic device of claim 7, wherein, when the sensor driver is operated in a second charging drive mode that is different from the first charging drive mode, the charging loop comprises a first fine charging loop in a first time interval in the second charging drive mode, and a second fine charging loop in a second time interval that is temporally continuous with the first time interval in the second charging drive mode,
wherein one or more of the W first loop electrodes in the first fine charging loop, and one or more of the W first loop electrodes in the second fine charging loop, overlap each other, and
wherein one or more of the X second loop electrodes in the first fine charging loop, and one or more of the X second loop electrodes in the second fine charging loop, overlap each other.

9. The electronic device of claim 8, wherein, when an input by a pen is sensed in the first charging drive mode, the sensor driver is configured to be switched from the first charging drive mode to a first local charging drive mode, and
wherein, in the first local charging drive mode, the sensor driver is configured to output the first signal to the W first loop electrodes, and to output the second signal to the X second loop electrodes, so that the charging loop overlaps an area in which the input by the pen is sensed.

10. The electronic device of claim 9, wherein the sensor driver is configured to be operated in the first local charging drive mode and then switched to the second charging drive mode,
wherein the W first loop electrodes in the first fine charging loop, and the W first loop electrodes in the second fine charging loop, overlap one or more of the W first loop electrodes in the charging loop in the first local charging drive mode,
wherein the X second loop electrodes in the first fine charging loop, and the X second loop electrodes in the second fine charging loop, overlap one or more of the X second loop electrodes in the charging loop in the first local charging drive mode,
wherein the sensor driver is configured to be operated in the second charging drive mode and then switched to a second local charging drive mode, and
wherein the charging loop in the second local charging drive mode is one of the first fine charging loop or the second fine charging loop in the second charging drive mode.

11. The electronic device of claim 5, wherein the charging electrodes comprise U gap electrodes between the W first loop electrodes and the X second loop electrodes, U being an integer that is greater than or equal to one, and
wherein the W first loop electrodes, the U gap electrodes, and the X second loop electrodes are continuously and sequentially arranged in the first direction.

12. The electronic device of claim 1, further comprising:
first electrodes overlapping the charging electrodes in one-to-one correspondence; and
second electrodes crossing the first electrodes, and spaced apart from each other in a second direction crossing the first direction.

13. An electronic device comprising:
first electrodes arranged in a first direction, and extending in a second direction crossing the first direction;
second electrodes arranged in the second direction, and extending in the first direction;
third electrodes arranged in the first direction, and extending in the second direction;
primary binder circuits configured to be selectively connected to one or more of the third electrodes;
secondary binder circuits configured to be selectively connected to one or more of the primary binder circuits; and
a sensor driver configured to provide a charging loop by outputting a first signal to at least one of the secondary binder circuits, and by outputting a second signal that is different from the first signal to at least one other of the secondary binder circuits in a charging drive mode.

14. The electronic device of claim 13, wherein the primary binder circuits comprise first switches connected to a first node, and
wherein the secondary binder circuits comprise second switches connected to a second node.

15. The electronic device of claim 13, wherein the third electrodes comprise W first loop electrodes configured to receive the first signal, W being an integer that is greater than or equal to one, X second loop electrodes configured to receive the second signal, X being an integer that is greater than or equal to one, and U gap electrodes between the W first loop electrodes and the X second loop electrodes, U being an integer that is greater than or equal to one,
wherein the W first loop electrodes, the U gap electrodes, and the X second loop electrodes are continuously and sequentially arranged in the first direction,
wherein the charging loop comprises the W first loop electrodes and the X second loop electrodes,
wherein the charging drive mode comprises a first charging drive mode, a first local charging drive mode, a second charging drive mode, and a second local charging drive mode, and
wherein, when an input by a pen is sensed in the first charging drive mode, the sensor driver is configured to be sequentially switched to the first local charging drive mode, the second charging drive mode, and the second local charging drive mode.

16. The electronic device of claim 15, wherein, in each of the first local charging drive mode and the second local charging drive mode, connection between the primary binder circuits and the secondary binder circuits is controlled so that the charging loop overlaps an area in which the input by the pen is sensed.

17. The electronic device of claim 15, wherein, in the first charging drive mode and the second charging drive mode, the charging loop is provided as a plurality of charging loops spaced apart from each other in the first direction, and
wherein a pitch between the charging loops in the first charging drive mode is greater than a pitch between the charging loops in the second charging drive mode.

18. A method of driving an electronic device, the method comprising:
controlling primary binder circuits to be selectively connected to one or more of charging electrodes arranged in a first direction;
controlling secondary binder circuits to be selectively connected to one or more of the primary binder circuits; and
outputting a first signal to at least one of the secondary binder circuits, outputting a second signal that is different from the first signal to at least one other of the secondary binder circuits, and forming a charging loop comprising one or more of the charging electrodes.

19. The method of claim 18, further comprising sequentially forming the charging loop while the charging loop moves in the first direction in a first charging drive mode.

20. The method of claim 19, further comprising:
switching the first charging drive mode to a first local charging drive mode, when an input by a pen is sensed in the first charging drive mode, to form the charging loop overlapping an area in which the input by the pen is sensed;
switching to a second charging drive mode from the first local charging drive mode; and
sequentially forming the charging loop while the charging loop moves in the first direction in the second charging drive mode,
wherein a pitch between adjacent charging loops in the first charging drive mode is greater than a pitch between adjacent charging loops in the second charging drive mode.
